(19) United States
(12) Patent Application Publication
(10) Pub. No.: US 2026/0253604 A1
(43) Pub. Date: Aug. 27, 2026

(54) SYSTEM

(71) Applicant: SoftBank Group Corp., Tokyo (JP)

(72) Inventor: Daisuke SAKAMOTO, Tokyo (JP)

(73) Assignee: SoftBank Group Corp., Tokyo (JP)

(21) Appl. No.: 19/534,788

(22) Filed: Feb. 10, 2026

(30) Foreign Application Priority Data
Feb. 21, 2025 (JP) 2025-027061

(51) Int. Cl. G10L 25/63; G06F 18/23; G06F 40/268; G06F 40/30; G10L 15/16

(52) U.S. Cl. CPC G10L 25/63; G06F 18/23; G06F 40/268; G06F 40/30; G10L 15/16

(57) ABSTRACT

The system according to the embodiment comprises a collection unit, an analysis unit, a generation unit, and a visualization unit. The collection unit collects user behavior data. The analysis unit analyzes the data collected by the collection unit and extracts talk content of users in each age group. The generation unit generates topic rankings by age group based on the talk content extracted by the analysis unit. The visualization unit visualizes the rankings generated by the generation unit to users.

### CROSS-REFERENCE TO RELATED APPLICATION

The present application claims priority to and incorporates by reference the entire contents of Japanese Patent Application No. 2025-027061 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it has not been possible to provide topic rankings by age group, resulting in the problem that users find it difficult to obtain information suited to themselves.

### SUMMARY OF THE INVENTION

The system according to the embodiment comprises a collection unit, an analysis unit, a generation unit, and a visualization unit. The collection unit collects user behavior data. The analysis unit analyzes the data collected by the collection unit and extracts talk content of users in each age group. The generation unit generates topic rankings by age group based on the talk content extracted by the analysis unit. The visualization unit visualizes the rankings generated by the generation unit to users.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

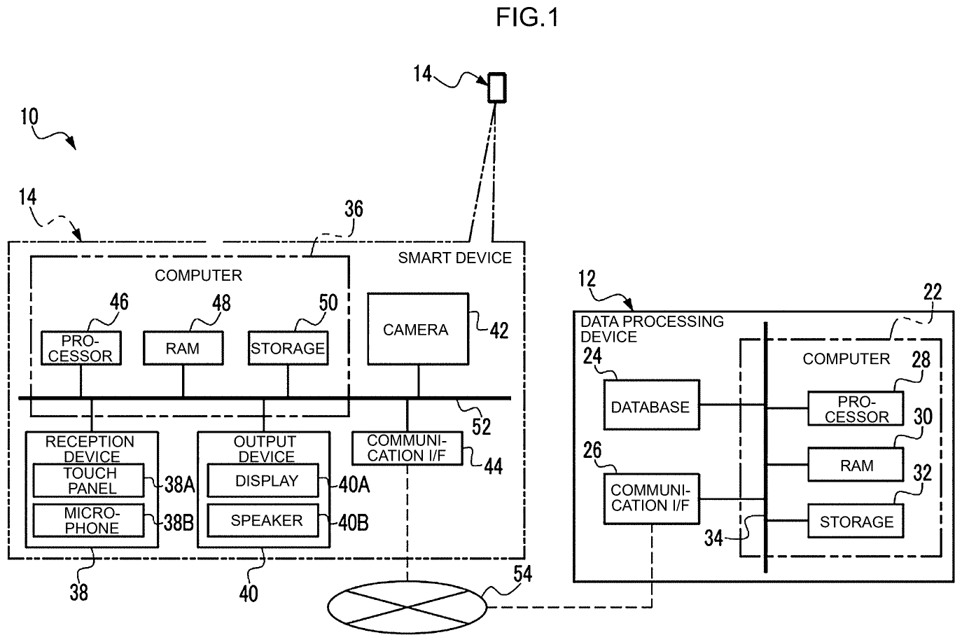

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

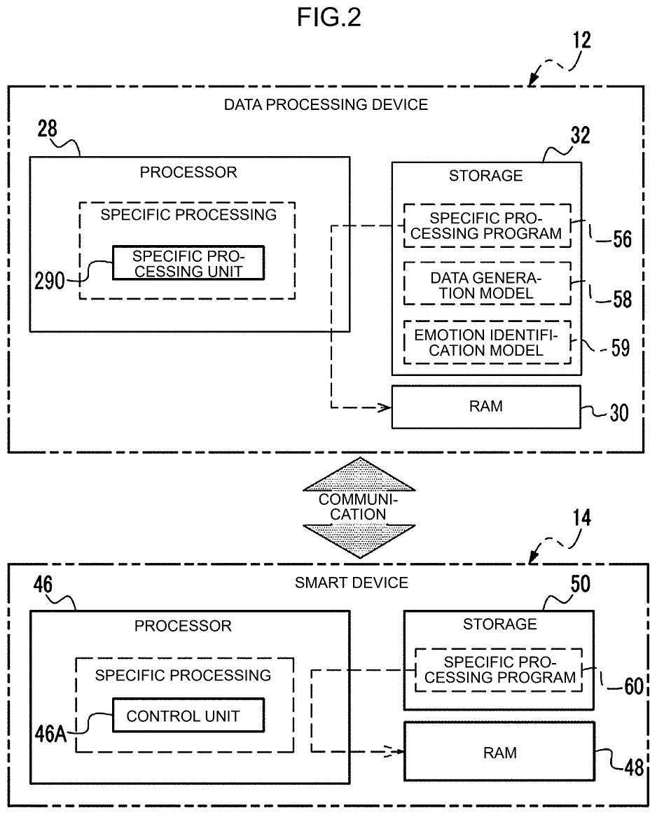

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a service that introduces what topics users in each age group are discussing, based on user behavior on a messenger application. This system collects, analyzes, generates, and visualizes user behavior data to create topic rankings by age group. For example, user behavior data from the messenger application is collected, and the collected data is analyzed to extract the talk content of users in each age group. Next, topic rankings by age group are generated based on the extracted talk content. These rankings are visualized to users, providing information on what topics users in each age group are discussing. As a result, users can obtain information suited to themselves. Furthermore, as users find the service interesting, they are encouraged to add demographic information to their accounts. For example, user behavior data from the messenger application is collected, including detailed data such as what users are talking about and which words are frequently used. This may include content users discuss with friends or topics in group chats, allowing the system to grasp users' talk content. Next, the collected data is analyzed to extract the talk content of users in each age group. The analysis utilizes the age estimation function of the messenger application. For example, the system estimates age group based on user profile information or talk content, and classifies the talk content of users in each age group. This enables identification of what topics users in each age group are discussing. Furthermore, topic rankings by age group are generated based on the extracted talk content. For example, words most discussed by teenage users or words frequently used by users in their twenties are displayed in a ranking format, allowing users to quickly grasp what topics are being discussed in each age group. These rankings are visualized to users, for example, on the home screen of the messenger application or on a dedicated ranking page, enabling users to easily obtain information suited to themselves. For instance, teenage users can learn what topics other users of the same age group are discussing, and users in their twenties can find topics that match their interests. Additionally, as users find the service interesting, they are encouraged to add demographic information to their accounts. For example, by registering their own age group or interests, users are provided with more accurate rankings, allowing them to obtain even more relevant information. Thus, the system provides a service that introduces what topics users in each age group are discussing, based on user behavior on the messenger application. Specifically, the system collects multidimensional information as user behavior data, such as message send/receive history, utterance content in talk rooms, frequency of stamp and emoji usage, presence of URL sharing or image attachments in talks, as a time-series tensor (e.g., user×time×utterance content×meta information). The system acquires these data in real time or batch processing via the collection unit and stores them in a database. Next, the analysis unit applies natural language processing algorithms (e.g., morphological analysis, BERT-based contextual embedding, topic modeling such as LDA) to the collected data to extract feature vectors from each utterance (e.g., 300-dimensional word embedding vectors or TF-IDF scores). Furthermore, user profile information (age, gender, occupation, registered region, etc.) and age attributes estimated from talk content (e.g., if age is not specified, the AI model estimates age group from vocabulary and topic trends) are combined to assign age group labels to each user. Examples of AI model input include “User A's utterance content over the past 30 days (text array), profile information (age: not registered, gender: female, occupation: student)” or “User B's group chat utterances (time-series text), stamp usage history.” Examples of AI model output include “Estimated age group: teens, main topics: music, games, school” and “Estimated age group: twenties, main topics: job hunting, travel, gourmet,” resulting in structured data. The system aggregates the frequency of topic words by age group based on these outputs, and the ranking generation unit generates ranking data (e.g., age group×topic word×score). The ranking generation unit uses not only simple frequency aggregation but also co-occurrence network analysis and clustering (e.g., k-means method) to generate rankings that take into account topic relevance and trendiness. The generated rankings are displayed by the visualization unit on the user interface in formats such as graphs, word clouds, or lists. The visualization unit automatically selects the optimal display layout according to the user's device type (smartphone, tablet, PC) and screen size. Furthermore, when users register their own age group or interests, the visualization unit presents personalized rankings to enhance the user experience. As a technical effect, the system achieves significant improvements in processing speed, ranking accuracy, and personalization for each user by realizing automatic classification and ranking generation by AI in a high-dimensional feature space, which differs from conventional simple aggregation or manual topic extraction. In addition, by promoting the addition of demographic information by users, the training data for the AI model is enhanced, creating a virtuous cycle for further accuracy improvement. Specific application fields include topic trend analysis for messenger applications, user attribute-based marketing for SNS, health monitoring of online communities, and extraction of age group-specific interest themes in the education field.

The information provision system according to the embodiment comprises a collection unit, an analysis unit, a generation unit, and a visualization unit. The collection unit collects user behavior data. User behavior data may include, for example, click data, browsing history, message content, and the like, but is not limited to such examples. The collection unit may collect user behavior data from a messenger application, for example. For instance, the collection unit can collect content that users discuss with friends or topics in group chats. Additionally, the collection unit can collect detailed data such as which words users frequently use. Thus, the collection unit can grasp the talk content of users. The analysis unit analyzes the data collected by the collection unit and extracts the talk content of users in each age group. The analysis unit may utilize the age estimation function of the messenger application to estimate age group from user profile information or talk content. For example, the analysis unit can estimate age group based on user profile information. The analysis unit can also analyze talk content to estimate age group. Thus, the analysis unit can classify the talk content of users in each age group. The generation unit generates topic rankings by age group based on the talk content extracted by the analysis unit. The generation unit may display, for example, words most discussed by users in each age group in a ranking format. For instance, the generation unit can display, in a ranking format, words most discussed by teenage users or words frequently used by users in their twenties. Thus, the generation unit can allow users to quickly grasp what topics are being discussed in each age group. The visualization unit visualizes the rankings generated by the generation unit to users. The visualization unit may display the rankings on the home screen of the messenger application or on a dedicated ranking page, for example. For instance, the visualization unit can display the rankings on the home screen of the messenger application, or on a dedicated ranking page. Thus, the visualization unit can visualize the rankings to users. As a result, the information provision system according to the embodiment can collect, analyze, generate, and visualize topic rankings by age group based on user behavior data. For example, users can obtain information suited to themselves. Furthermore, as users find the service interesting, they are encouraged to add demographic information to their accounts. For example, by registering their own age group or interests, users are provided with more accurate rankings, allowing them to obtain even more relevant information. Specifically, the information provision system acquires user behavior data as a multidimensional tensor (e.g., user ID×time×utterance content×meta information) in real time or batch via the collection unit and stores it in a database. The system individually collects click data (e.g., button ID, click time), browsing history (e.g., page URL, dwell time), message content (e.g., text, stamps, image attachment information), and manages them in time series for each user. The analysis unit applies natural language processing algorithms (e.g., morphological analysis, BERT-based contextual embedding, topic extraction by LDA) to the collected data to extract feature vectors from each utterance (e.g., 300-dimensional word embedding vectors, TF-IDF scores). Furthermore, user profile information (age, gender, occupation, region, etc.) and age attributes estimated from talk content (AI model estimates age group from vocabulary and topic trends) are combined to assign age group labels to each user. Examples of AI model input include “User A's utterance content over the past 30 days (text array), profile information (age: not registered, gender: female, occupation: student)” or “User B's group chat utterances (time-series text), stamp usage history.” Examples of AI model output include “Estimated age group: teens, main topics: music, games, school” and “Estimated age group: twenties, main topics: job hunting, travel, gourmet,” resulting in structured data. The generation unit aggregates the frequency of topic words by age group based on these outputs, and the ranking generation unit generates ranking data (e.g., age group ×topic word ×score). The ranking generation unit uses not only simple frequency aggregation but also co-occurrence network analysis and clustering (e.g., k-means method) to generate rankings that take into account topic relevance and trendiness. The visualization unit displays the generated rankings on the user interface in formats such as graphs, word clouds, or lists, and automatically selects the optimal display layout according to the user's device type (smartphone, tablet, PC) and screen size. Furthermore, when users register their own age group or interests, the visualization unit presents personalized rankings to enhance the user experience. As a technical effect, the system achieves significant improvements in processing speed, ranking accuracy, and personalization for each user by realizing automatic classification and ranking generation by AI in a high-dimensional feature space, which differs from conventional simple aggregation or manual topic extraction. In addition, by promoting the addition of demographic information by users, the training data for the AI model is enhanced, creating a virtuous cycle for further accuracy improvement. Specific application fields include topic trend analysis for messenger applications, user attribute-based marketing for SNS, health monitoring of online communities, and extraction of age group-specific interest themes in the education field.

The analysis unit may comprise an estimation unit configured to estimate the age group from user profile information or talk content. The estimation unit may estimate the age group based on user profile information, for example. Profile information may include, for example, age, gender, occupation, and the like, but is not limited to such examples. The estimation unit may analyze user profile information to estimate the age group. The estimation unit may also analyze talk content to estimate the age group. For example, the estimation unit may analyze the user's talk content to estimate the age group. Thus, the estimation unit can estimate the age group from user profile information or talk content. As a result, the analysis unit can generate more accurate topic rankings by age group. Specifically, the analysis unit may implement a deep neural network as the estimation unit, particularly a classifier using a BERT-based contextual embedding model or Transformer architecture. The estimation unit encodes user profile information (e.g., categorical data such as age, gender, occupation, registered region) using one-hot encoding or embedding vectors, and preprocesses talk content (e.g., utterance text array over the past 30 days, time of each utterance, utterance length, frequency of used words) using natural language processing (e.g., tokenization, stop word removal, morphological analysis), then inputs it as a tensor (e.g., user×feature dimension×time series length) to the AI model. Examples of input include “User A: age not registered, gender female, occupation student, utterance text array over the past 30 days” and “User B: age not registered, gender male, occupation company employee, group chat utterance history.” The estimation unit integrates these multidimensional inputs, extracts contextual features using the encoder layers of BERT or Transformer, and outputs age group labels (e.g., teens, twenties, thirties, forties and above) via fully connected layers. Examples of output include “Estimated age group: teens, confidence 0.92” and “Estimated age group: twenties, confidence 0.85,” resulting in structured data. Furthermore, the estimation unit extracts features such as vocabulary trends and topic distribution (e.g., TF-IDF scores, topic distribution vectors) from talk content and uses them as auxiliary information for age group estimation. The estimation unit optimizes weights using a cross-entropy loss function with a labeled dataset for supervised learning, continuously improving estimation accuracy. In subsequent processing, the estimated age group labels are passed to the topic ranking generation unit and used as keys for age group-based topic aggregation and ranking generation. As a technical effect, the estimation unit achieves improved accuracy, faster estimation speed, and better generalization to unknown users by integrating multiple information sources in a high-dimensional feature space and realizing automatic classification by AI, which differs from static reference to profile information or manual age group estimation. Specific application fields include user attribute estimation for messenger applications, demographic analysis for SNS, targeting for online advertising, and age group-based learning support in the education field.

The analysis unit may analyze talk content using natural language processing technology. The analysis unit may analyze talk content using natural language processing technology, for example. Natural language processing technology may include, for example, morphological analysis, grammatical analysis, semantic analysis, and the like, but is not limited to such examples. The analysis unit may analyze talk content using morphological analysis, for example. The analysis unit may also analyze talk content using grammatical analysis. Furthermore, the analysis unit may analyze talk content using semantic analysis. For example, the analysis unit may extract words from talk content using morphological analysis, analyze sentence structure using grammatical analysis, and analyze sentence meaning using semantic analysis. Thus, the analysis unit can analyze talk content using natural language processing technology. As a result, the analysis unit can improve the accuracy of talk content analysis. Specifically, the analysis unit uses a morphological analysis engine (e.g., MeCab or Janome) to segment Japanese text into words and assign part-of-speech information to each word. Next, the grammatical analysis module applies dependency structure analysis algorithms (e.g., CaboCha) to extract structural relationships such as subject, predicate, and object in sentences. Furthermore, the semantic analysis module uses BERT or Transformer-based contextual embedding models to generate semantic vectors (e.g., 768-dimensional sentence embedding vectors) for each utterance. Examples of input include text data such as “User A's utterance: ‘I bought a new game yesterday’” and “User B's utterance: ‘I'm planning to travel next week.’” The analysis unit converts these texts into word sequences via morphological analysis, generates syntax trees via grammatical analysis, and extracts contextual vectors via semantic analysis. Examples of output include “Word sequence: yesterday/new/game/bought/yo,” “Syntax tree: subject-predicate-object structure,” and “Semantic vector: [−0.12, 0.34, . . . ].” Furthermore, the analysis unit inputs the extracted feature vectors into clustering or topic modeling (e.g., LDA) to analyze topic distribution and trendiness. In subsequent processing, the analysis results are passed to the age estimation unit or ranking generation unit and used as basic data for user attribute estimation and topic ranking generation. As a technical effect, the analysis unit achieves high-precision and high-speed contextual understanding and complex topic extraction by applying advanced natural language processing algorithms in multiple stages, which differs from simple keyword extraction or manual content classification. This improves the accuracy of topic rankings, enhances user experience, and automates and streamlines the entire system. Specific application fields include talk analysis for messenger applications, trend analysis for SNS, automated response for customer support, and essay evaluation in the education field.

The generation unit may display, in a ranking format, words that users in each age group are discussing. The generation unit may display, in a ranking format, words that users in each age group are discussing, for example. Topic words may include words extracted by methods such as frequency of occurrence or co-occurrence network analysis, but are not limited to such examples. The generation unit may extract topic words based on frequency of occurrence and display them in a ranking format, for example. The generation unit may also extract topic words using co-occurrence network analysis and display them in a ranking format. For example, the generation unit may extract topic words based on frequency of occurrence and display them in a ranking format. The generation unit may also extract topic words using co-occurrence network analysis and display them in a ranking format. Thus, the generation unit can display, in a ranking format, words that users in each age group are discussing. As a result, the generation unit enables users to easily obtain information suited to themselves. Specifically, the generation unit receives age-labeled talk content and feature vectors from the analysis unit and first aggregates the frequency of topic words for each age group. Examples of input include “Word list of utterances by teenage users: [‘game’, ‘music’, ‘friend’, . . . ]” and “Word list of utterances by users in their twenties: [‘work’, ‘travel’, ‘gourmet’, . . . ].” The generation unit applies TF-IDF scores or simple frequency aggregation to these word lists to extract the top N topic words. Furthermore, the co-occurrence network analysis module constructs a co-occurrence matrix (e.g., word ×word co-occurrence count matrix), calculates network centrality indices (e.g., PageRank, Degree Centrality), and generates rankings that take into account topic relevance and trendiness. Examples of output include “Teenage ranking: 1st ‘game’ (score 0.92), 2nd ‘music’ (0.85), 3rd ‘friend’ (0.81)” and “Twenties ranking: 1st ‘work’ (0.88), 2nd ‘travel’ (0.83), 3rd ‘gourmet’ (0.80),” resulting in structured data. The generation unit outputs these ranking data to the visualization unit in JSON format or as database tables. In subsequent processing, the visualization unit displays the rankings on the user interface in formats such as graphs, word clouds, or lists, allowing users to easily grasp topics that match their age group or interests. As a technical effect, the generation unit achieves high-precision ranking generation that reflects topic relevance and trendiness by combining high-dimensional feature analysis by AI and network theory, which differs from simple frequency aggregation or manual topic extraction. This improves personalization for each user, enhances the reliability of rankings, and automates and streamlines the entire system. Specific application fields include topic trend analysis for messenger applications, marketing for SNS, health monitoring of online communities, and extraction of interest themes in the education field.

The visualization unit may display the ranking on the home screen of the messenger application or on a dedicated ranking page. The visualization unit may display the ranking on the home screen of the messenger application, for example. The home screen may include, for example, the display position of the ranking, display format, and the like, but is not limited to such examples. The visualization unit may display the ranking at a specific position on the home screen, for example. The visualization unit may also display the ranking on a dedicated ranking page. The dedicated ranking page may include, for example, page layout, display items, and the like, but is not limited to such examples. The visualization unit may display the ranking in a specific layout on the dedicated ranking page, for example. Thus, the visualization unit can display the ranking on the home screen of the messenger application or on a dedicated ranking page. As a result, the visualization unit enables users to easily obtain information suited to themselves. Specifically, the visualization unit automatically converts the ranking data (e.g., structured data of age group ×topic word ×score) received from the generation unit into the optimal display layout according to the user's device type (smartphone, tablet, PC), screen size, and user operation history. Examples of input include “Teenage ranking data: 1st ‘game’, 2nd ‘music’, 3rd ‘friend’” and “Twenties ranking data: 1st ‘work’, 2nd ‘travel’, 3rd ‘gourmet’.” The visualization unit displays these data as a vertical scroll list for smartphones, horizontal scroll or grid format for tablets, and graphs or word clouds for PCs. Furthermore, the visualization unit can implement interaction functions such as pop-up display of detailed information or related talk content when users tap or click on ranking items. Examples of output include “Smartphone screen: vertical list format displaying 1st to 10th place,” “Tablet screen: two-column grid displaying rankings,” and “PC screen: bar graph plus word cloud.” In subsequent processing, the visualization unit collects user operation history and feedback and utilizes them for display layout optimization and personalization. As a technical effect, the visualization unit achieves improved user experience, information acquisition efficiency, and system flexibility by automatically realizing dynamic layout optimization according to device information and user behavior, which differs from static ranking display or manual screen design. Specific application fields include ranking display for messenger applications, trend visualization for SNS, presentation of interest themes for online learning platforms, and marketing dashboards.

The visualization unit may provide a more accurate ranking by allowing users to register their own age group or interests. The visualization unit may provide a more accurate ranking by allowing users to register their own age group or interests, for example. Interests may include, for example, hobbies, topics of interest, and the like, but are not limited to such examples. The visualization unit may provide age group-based rankings by allowing users to register their own age group, for example. The visualization unit may also provide rankings based on interests by allowing users to register their own interests. For example, the visualization unit may provide age group-based rankings by allowing users to register their own age group. The visualization unit may also provide rankings based on interests by allowing users to register their own interests. Thus, the visualization unit can provide a more accurate ranking by allowing users to register their own age group or interests. As a result, the visualization unit enables users to obtain even more relevant information. Specifically, the visualization unit registers user-input age information (e.g., teens, twenties, thirties, etc.) and interest tags (e.g., music, sports, travel, gourmet, etc.) in a database, and generates personalized rankings by combining them with ranking data received from the generation unit. Examples of input include “User C: age group twenties, interest tags: music, travel” and “User D: age group not registered, interest tags: games, gourmet.” The visualization unit performs filtering and score weighting based on age group match and interest tag match, and displays an optimized ranking list for each user. Examples of output include “Ranking for twenties and music lovers: 1st ‘live concert’, 2nd ‘new song’, 3rd ‘festival’” and “Ranking for users interested in games and gourmet: 1st ‘new game’, 2nd ‘cafe’, 3rd ‘sweets’.” Furthermore, the visualization unit learns from user registration information and past ranking viewing history, and can apply recommendation algorithms (e.g., collaborative filtering, content-based recommendation) to automatically suggest highly relevant topics. In subsequent processing, user feedback and operation history are collected and utilized for continuous optimization of ranking generation and display logic. As a technical effect, the visualization unit achieves improved ranking accuracy, user satisfaction, and system adaptability by combining user input information and AI-based automatic recommendation, which differs from simple overall ranking display or manual personalization. Specific application fields include personalized display for messenger applications, interest-based trend presentation for SNS, individual optimization for online learning, and targeted information provision in marketing.

The collection unit may estimate a user's emotion and adjust the timing of data collection based on the estimated emotion of the user. The collection unit may estimate a user's emotion and adjust the timing of data collection based on the estimated emotion of the user, for example. Emotion estimation may include technologies such as facial expression recognition and voice analysis, but is not limited to such examples. For example, if the user is feeling stressed, the collection unit can reduce the frequency of data collection to lessen the user's burden. If the user is relaxed, the collection unit can increase the frequency of data collection to collect more detailed data. Furthermore, if the user is excited, the collection unit can collect data in real time to capture immediate reactions. Thus, the collection unit can adjust the timing of data collection based on the user's emotion, reducing user burden and enabling the collection of detailed data. Emotion estimation may be realized using emotion engines or generative AI, for example. Generative AI may include text generation AI (e.g., LLM) or multimodal generative AI, but is not limited to such examples. Specifically, the collection unit is equipped with a facial expression recognition module that extracts facial feature points (e.g., movement of the corners of the eyes, raising or lowering of the corners of the mouth, wrinkles between the eyebrows) from camera images, and a voice analysis module that extracts voice spectral features (e.g., pitch, speech rate, intonation, length of silent intervals) from microphone input. The collection unit inputs these multidimensional features (e.g., 68 landmark coordinate arrays extracted from facial images, MFCC vectors or zero-crossing rates extracted from voice) as time-series tensors to the AI model. The AI model may use a multimodal Transformer or a combination of convolutional neural networks and recurrent neural networks as an emotion classifier. Examples of input include “User A's sequence of facial image frames plus voice waveform data (3 seconds)” and “User B's utterance text plus real-time facial feature vector.” Examples of AI model output include “Estimated emotion: stress, confidence 0.88,” “Estimated emotion: relaxation, confidence 0.93,” and “Estimated emotion: excitement, confidence 0.81,” resulting in structured data. The collection unit automatically switches data collection frequency parameters (e.g., 1-minute intervals, 10-minute intervals, real-time continuous collection) according to each emotional state based on these outputs. In subsequent processing, changes in collection frequency are reflected in the database write scheduler and network communication module operation, optimizing user experience and balancing system load. As a technical effect, the collection unit achieves reduced user burden, improved quality of collected data, and increased system efficiency by realizing automatic control linked to real-time emotion estimation by AI, which differs from conventional fixed-interval data collection or manual timing adjustment. Furthermore, as emotion estimation accuracy improves, psychological stress on users is minimized while high-precision data can be obtained at necessary timings. Specific application fields include user experience optimization for messenger applications, health monitoring by wearable devices, presentation of teaching materials based on concentration estimation for online learning platforms, and stress detection and timing optimization for customer support.

The collection unit may analyze a user's past behavior data and select a data collection method. The collection unit may analyze a user's past behavior data and select a data collection method, for example. Past behavior data may include, for example, browsing history, purchase history, and the like, but is not limited to such examples. For example, the collection unit can prioritize data collection for messenger application features that the user has frequently used in the past. The collection unit may also analyze the user's past behavior patterns to determine the optimal timing for data collection. Furthermore, the collection unit may refer to the user's past talk content to collect highly relevant data. Thus, the collection unit can analyze a user's past behavior data and select a data collection method, enabling selection of the optimal data collection method based on user behavior. Specifically, the collection unit stores each user's past behavior data (e.g., click event logs, list of browsed page URLs, purchase history tables, talk history text arrays) in a time-series database and extracts these as feature vectors (e.g., function usage frequency vectors, activity distribution by time, number of purchases by category). The collection unit inputs these features to clustering algorithms (e.g., k-means, hierarchical clustering) or sequence pattern mining (e.g., Apriori algorithm, LSTM-based time-series prediction models) to automatically extract user behavior patterns. Examples of AI model input include “User A's click history over the past 30 days (time-series vector), distribution of browsed page categories” and “User B's purchase history (array of product IDs, purchase times).” Examples of AI model output include “Recommended collection method: prioritize message content, collection timing: nighttime” and “Recommended collection method: prioritize stamp usage history, collection timing: weekends,” resulting in structured data. The collection unit automatically optimizes parameters of the data collection module (e.g., type of data to collect, collection frequency, collection timing) based on these outputs. In subsequent processing, the optimized collection method contributes to database writing, network communication load balancing, and improved user experience. As a technical effect, the collection unit achieves reduction of unnecessary data collection, comprehensive acquisition of necessary data, and efficient use of system resources by realizing automatic optimization linked to AI-based analysis of past behavior, which differs from conventional uniform data collection or manual collection settings. Specific application fields include enhancement of personalization features for messenger applications, analysis of purchasing behavior for e-commerce sites, presentation of teaching materials based on learning history for online learning, and power-saving data collection control for IoT devices.

The collection unit may perform filtering during data collection based on the user's current activity status or field of interest. The collection unit may perform filtering during data collection based on the user's current activity status or field of interest, for example. Current activity status may include, for example, current location information, current activity, and the like, but is not limited to such examples. Field of interest may include, for example, topics of interest, accounts followed, and the like, but is not limited to such examples. For example, the collection unit can prioritize collection of content from group chats the user is currently participating in. The collection unit may also filter and collect talk content related to the user's current field of interest. Furthermore, the collection unit may adjust the scope of data collection according to the user's current activity status (e.g., working, on break). Thus, the collection unit can perform filtering during data collection based on the user's current activity status or field of interest, enabling collection of highly relevant data. Specifically, the collection unit acquires sensor data indicating the user's current activity status (e.g., movement state from accelerometer, location information from GPS, active window information from applications) and profile information indicating field of interest (e.g., interest tags, list of followed accounts, recent search words) in real time. The collection unit inputs these as multidimensional feature vectors (e.g., activity status one-hot vector, field of interest embedding vector) to the AI model and applies filtering rule generation algorithms (e.g., decision trees, random forests, rule-based classifiers). Examples of input include “User A: current location office, activity status: working, interest tags: business, IT” and “User B: current location cafe, activity status: on break, interest tags: gourmet, travel.” Examples of AI model output include “Collection target: business-related group chat, collection scope: utterance content plus attachments” and “Collection target: gourmet-related talk, collection scope: utterance content only,” resulting in structured data. The collection unit automatically sets filter conditions (e.g., target talk room ID, topic category, type of data to collect) for the data collection module based on these outputs. In subsequent processing, filtered data is efficiently passed to the analysis unit and ranking generation unit, contributing to improved processing efficiency and user experience for the entire system. As a technical effect, the collection unit achieves reduction of unnecessary data, comprehensive acquisition of highly relevant data, and optimization of system resources by realizing automatic filtering based on real-time situation recognition and field of interest estimation by AI, which differs from conventional full data collection or manual data selection. Specific application fields include context-adaptive data collection for messenger applications, interest-based trend analysis for SNS, context-aware data collection for IoT devices, and adaptive teaching material presentation for online learning.

The collection unit may estimate a user's emotion and determine the priority of data to be collected based on the estimated emotion of the user. The collection unit may estimate a user's emotion and determine the priority of data to be collected based on the estimated emotion of the user, for example. Emotion estimation may include technologies such as facial expression recognition and voice analysis, but is not limited to such examples. For example, if the user is feeling stressed, the collection unit can prioritize collection of data on relaxing topics. If the user is relaxed, the collection unit can prioritize collection of data on interesting topics. Furthermore, if the user is excited, the collection unit can prioritize collection of data on topics requiring immediate response. Thus, the collection unit can determine the priority of data to be collected based on the user's emotion, enabling prioritized collection of important data for the user. Emotion estimation may be realized using emotion engines or generative AI, for example. Generative AI may include text generation AI (e.g., LLM) or multimodal generative AI, but is not limited to such examples. Specifically, the collection unit is equipped with a multimodal AI model combining a facial expression recognition module (e.g., extraction of facial feature points from facial images), a voice analysis module (e.g., extraction of emotional features from voice waveforms), and a text analysis module (e.g., extraction of emotional vocabulary from utterance content). The collection unit inputs these features (e.g., facial landmark coordinates, MFCC vectors, emotional vocabulary scores) as input tensors to the AI model, which outputs emotion classification (e.g., stress, relaxation, excitement). Examples of input include “User A's facial image plus voice data plus utterance text” and “User B's voice only.” Examples of AI model output include “Estimated emotion: stress, confidence 0.90” and “Estimated emotion: relaxation, confidence 0.87,” resulting in structured data. The collection unit generates a priority list of data to be collected (e.g., relaxing topics when relaxed, highly time-sensitive topics when excited) according to the estimated emotion, and automatically switches the collection order and targets of the data collection module. In subsequent processing, high-priority data is quickly passed to the analysis unit and ranking generation unit, contributing to optimization of user experience and system efficiency. As a technical effect, the collection unit achieves data collection tailored to the user's psychological state, rapid acquisition of important data, and system-wide efficiency by realizing automatic priority control linked to real-time emotion estimation by AI, which differs from conventional uniform collection or manual priority setting. Specific application fields include emotion-adaptive data collection for messenger applications, stress monitoring by wearable devices, concentration-adaptive teaching material presentation for online learning, and emotion response optimization for customer support.

The collection unit may preferentially collect highly relevant data by considering the user's geographic location information during data collection. The collection unit may preferentially collect highly relevant data by considering the user's geographic location information during data collection, for example. Geographic location information may include, for example, GPS data, location information services, and the like, but is not limited to such examples. For example, the collection unit can prioritize collection of topics relevant to the region where the user is currently located. The collection unit may also collect region-specific talk content based on the user's geographic location information. Furthermore, if the user is traveling, the collection unit can prioritize collection of topics relevant to the travel destination. Thus, the collection unit can preferentially collect highly relevant data by considering the user's geographic location information during data collection, enabling collection of region-specific talk content. Specifically, the collection unit acquires GPS coordinates or Wi-Fi/Bluetooth-based location information from the user's device in real time and generates geographic feature vectors (e.g., latitude/longitude, region code, city/prefecture ID). The collection unit uses these location information to identify the user's current region cluster using geographic clustering algorithms (e.g., DBSCAN, k-means) or GIS APIs. Examples of input include “User A: latitude 35.68, longitude 139.76 (Chiyoda-ku, Tokyo)” and “User B: latitude 34.69, longitude 135.50 (Osaka City).” The collection unit cross-references region-specific topic trend databases and lists of region-specific talk content, and prioritizes collection of data relevant to the current location (e.g., regional events, local news, region-limited campaigns). Examples of output include “Topic data for Chiyoda-ku, Tokyo” and “Gourmet talk for Osaka City.” Furthermore, if the user is traveling, the collection unit automatically determines the travel destination based on movement history and length of stay, and prioritizes collection of travel destination-specific data. In subsequent processing, region-specific data is used by the analysis unit and ranking generation unit for region-based ranking generation and region trend analysis. As a technical effect, the collection unit achieves comprehensive acquisition of highly regional information, improved user experience, and increased accuracy of regional marketing by realizing automatic region-specific data collection linked to real-time location information analysis by AI, which differs from conventional full data collection or manual region determination. Specific application fields include region trend analysis for messenger applications, local event information distribution, information recommendation for tourist destinations, and effectiveness measurement of region-limited campaigns.

The collection unit may analyze the user's social media activity and collect relevant data during data collection. The collection unit may analyze the user's social media activity and collect relevant data during data collection, for example. Social media activity may include, for example, post content, number of likes, number of followers, and the like, but is not limited to such examples. For example, the collection unit can collect talk content related to content shared by the user on social media. The collection unit may also collect data by referring to the talk content of the user's followers or friends on social media. Furthermore, the collection unit can prioritize collection of topics that the user has shown interest in on social media. Thus, the collection unit can analyze the user's social media activity and collect relevant data during data collection, enabling collection of relevant data. Specifically, the collection unit acquires multidimensional information as social media activity data, such as post text, post time, tags or hashtags attached to posts, number of likes, number of shares, number of comments, number of followers, follow relationship graphs, groups or event information the user participates in, via API or scraping technology. The collection unit structures these data as multidimensional tensors of user ID×time×post content×meta information and stores them in a database. Furthermore, the collection unit collects metadata of URLs, images, and videos shared by the user and uses them as features for analyzing relevance to external content. Examples of AI model input include “User A's post text array over the past 30 days, time-series transitions of likes, shares, comments, number of followers” and “User B's follow relationship graph, list of participating groups, array of hashtags attached to posts.” The AI model receives these multidimensional features as input tensors and combines natural language processing algorithms (e.g., BERT-based contextual embedding, topic extraction by LDA), graph neural network-based social graph analysis, and time-series analysis (e.g., LSTM) to estimate the user's interest distribution, topic trends, and influence score. Examples of AI model output include “Main interest topics: music, travel, gourmet; influence score: 0.82; related user list: User C, User D” and “Priority collection topic: new movie; recommended collection target: followers' post content,” resulting in structured data. The collection unit automatically sets the collection targets (e.g., talk content on specific topics, followers' posts, conversation history of related groups) and collection priorities of the data collection module based on these outputs. In subsequent processing, the collected data is passed to the analysis unit and used as basic data for analyzing user interest trends and generating topic rankings. As a technical effect, the collection unit achieves high-precision and real-time understanding of user interests and influence, and comprehensive and efficient collection of relevant data by combining multidimensional feature analysis by AI and social graph analysis, which differs from conventional simple post history collection or manual topic extraction. This improves the accuracy of topic rankings, enhances personalization for each user, and automates and streamlines the entire system. Specific application fields include topic trend analysis for messenger applications, influencer analysis for SNS, extraction of target users in marketing, health monitoring of online communities, and effectiveness measurement of event promotion.

The analysis unit may estimate a user's emotion and adjust the expression method of analysis based on the estimated emotion of the user. The analysis unit may estimate a user's emotion and adjust the expression method of analysis based on the estimated emotion of the user, for example. Emotion estimation may include technologies such as facial expression recognition and voice analysis, but is not limited to such examples. For example, if the user is feeling stressed, the analysis unit can provide simple and easy-to-understand analysis results. If the user is relaxed, the analysis unit can provide detailed analysis results. Furthermore, if the user is excited, the analysis unit can provide visually attractive analysis results. Thus, the analysis unit can adjust the expression method of analysis based on the user's emotion, enabling provision of easy-to-understand analysis results for the user. Emotion estimation may be realized using emotion engines or generative AI, for example. Generative AI may include text generation AI (e.g., LLM) or multimodal generative AI, but is not limited to such examples. Specifically, the analysis unit is equipped with a multimodal AI model combining a facial expression recognition module (e.g., extraction of facial feature points from camera images), a voice analysis module (e.g., extraction of MFCC or pitch features from voice waveforms), and a speech text analysis module (e.g., emotional vocabulary scoring). The analysis unit inputs these features (e.g., facial landmark coordinate arrays, voice spectral vectors, emotional vocabulary frequency vectors) as input tensors to the AI model, which outputs emotion classification (e.g., stress, relaxation, excitement). Examples of input include “User A's facial image plus voice data plus utterance text” and “User B's voice only.” Examples of AI model output include “Estimated emotion: stress, confidence 0.91” and “Estimated emotion: relaxation, confidence 0.88,” resulting in structured data. The analysis unit automatically switches the expression method of analysis results (e.g., simple text summary, detailed report with graphs, visual display emphasizing animation or color) according to the estimated emotion. For example, in a stress state, only the main points are presented as bullet points; in a relaxed state, detailed statistical graphs or topic distribution diagrams are displayed; and in an excited state, interactive visuals or animations are used. In subsequent processing, the analysis results are passed to the visualization unit and presented in an interface optimized for the user's emotional state. As a technical effect, the analysis unit achieves improved user experience, information comprehension, and system flexibility by realizing automatic expression optimization linked to real-time emotion estimation by AI, which differs from conventional uniform analysis result display or manual expression adjustment. Specific application fields include dashboard display for messenger applications, trend analysis reports for SNS, progress feedback for online learning, and stress-adaptive response for customer support.

The analysis unit may adjust the level of detail of analysis based on the importance of the data during analysis. The analysis unit may adjust the level of detail of analysis based on the importance of the data during analysis, for example. Importance of data may include, for example, frequency of occurrence, user interest level, and the like, but is not limited to such examples. For example, the analysis unit can perform detailed analysis for highly important data. The analysis unit may also perform simplified analysis for less important data. Furthermore, the analysis unit may perform moderately detailed analysis for data of medium importance. Thus, the analysis unit can adjust the level of detail of analysis based on the importance of the data during analysis, enabling detailed analysis for important data. Specifically, the analysis unit quantitatively evaluates the importance of each data item by calculating features such as frequency of occurrence score, user interest score (e.g., number of clicks, viewing time, number of likes), and topic trend score (e.g., increase rate over the past 7 days). These features are input as feature vectors (e.g., data ID×feature dimension) to the AI model. The AI model controls branching of the analysis pipeline based on the importance score. Examples of input include “Data A: frequency 0.95, interest 0.88, trend 0.91” and “Data B: frequency 0.32, interest 0.21, trend 0.15.” Examples of AI model output include “Analysis detail level: high (detailed analysis applied)” and “Analysis detail level: low (summary analysis applied),” resulting in control signals. When the detail level is high, the analysis unit applies natural language processing algorithms (e.g., BERT-based contextual embedding, topic distribution estimation by LDA, co-occurrence network analysis) in multiple stages to perform detailed topic extraction and relationship analysis. When the detail level is low, only simple frequency aggregation or keyword extraction is performed. In subsequent processing, the analysis results are passed to the generation unit and visualization unit and presented to users at the optimal information granularity. As a technical effect, the analysis unit achieves optimization of computational resources, concentration of analysis resources on important data, and improved user experience by realizing automatic detail level control linked to AI-based importance evaluation, which differs from conventional uniform analysis processing or manual detail level adjustment. Specific application fields include topic ranking generation for messenger applications, trend analysis for SNS, extraction of key points for online learning, and analysis of popular products in marketing.

The analysis unit may apply different analysis algorithms according to the category of data during analysis. The analysis unit may apply different analysis algorithms according to the category of data during analysis, for example. Data categories may include, for example, text data, image data, voice data, and the like, but are not limited to such examples. For example, the analysis unit can apply natural language processing algorithms to text data. The analysis unit may also apply image analysis algorithms to image data. Furthermore, the analysis unit may apply voice analysis algorithms to voice data. Thus, the analysis unit can apply different analysis algorithms according to the category of data during analysis, enabling optimal analysis according to the characteristics of the data. Specifically, the analysis unit is equipped with a data category determination module that automatically determines the category of input data (e.g., text, image, voice) based on meta information (e.g., file extension, MIME type, data structure) and content features (e.g., text length, image resolution, voice sample rate). Examples of input include “Data A: text (UTF-8), length 120 characters,” “Data B: image (JPEG), resolution 640×480,” and “Data C: voice (WAV), sample rate 16 kHz.” The analysis unit applies morphological analysis, BERT-based contextual embedding, and topic extraction by LDA to text data; convolutional neural network (CNN)-based image feature extraction, object detection, and image classification to image data; and MFCC extraction, voice recognition, and emotion classification to voice data. Examples of AI model output include “Data A: main topic ‘travel’, topic distribution [0.7, 0.2, 0.1],” “Data B: detected object ‘cafe’, confidence 0.93,” and “Data C: estimated emotion ‘relaxation’, confidence 0.89,” resulting in structured data. In subsequent processing, the analysis results are passed to the generation unit and visualization unit, enabling optimized rankings and displays for each category. As a technical effect, the analysis unit achieves improved analysis accuracy, faster processing speed, and increased system flexibility by realizing automatic category determination and optimal algorithm selection by AI, which differs from conventional uniform application of analysis algorithms or manual data classification. Specific application fields include multimedia analysis for messenger applications, image and voice trend analysis for SNS, automatic classification of teaching materials for online learning, and multimodal response for customer support.

The analysis unit may estimate a user's emotion and adjust the length of analysis based on the estimated emotion of the user. The analysis unit may estimate a user's emotion and adjust the length of analysis based on the estimated emotion of the user, for example. Emotion estimation may include technologies such as facial expression recognition and voice analysis, but is not limited to such examples. For example, if the user is in a hurry, the analysis unit can provide concise analysis results that focus on key points. If the user is relaxed, the analysis unit can provide detailed analysis results. Furthermore, if the user is excited, the analysis unit can provide visually attractive analysis results. Thus, the analysis unit can adjust the length of analysis based on the user's emotion, enabling provision of analysis results suited to the user's situation. Emotion estimation may be realized using emotion engines or generative AI, for example. Generative AI may include text generation AI (e.g., LLM) or multimodal generative AI, but is not limited to such examples. Specifically, the analysis unit is equipped with a multimodal AI model combining a facial expression recognition module (e.g., extraction of feature points from facial images), a voice analysis module (e.g., extraction of emotional features from voice waveforms), and a text analysis module (e.g., extraction of emotional vocabulary from utterance content). The analysis unit inputs these features (e.g., facial landmark coordinates, MFCC vectors, emotional vocabulary scores) as input tensors to the AI model, which outputs emotion classification (e.g., in a hurry, relaxation, excitement). Examples of input include “User A's facial image plus voice data plus utterance text” and “User B's voice only.” Examples of AI model output include “Estimated emotion: in a hurry, confidence 0.92” and “Estimated emotion: relaxation, confidence 0.89,” resulting in structured data. The analysis unit automatically switches the length of analysis results (e.g., summary only, detailed report, interactive visualized detailed display) according to the estimated emotion. For example, in a hurry, only the main points are presented in short sentences; in a relaxed state, detailed statistical graphs or topic distribution diagrams are displayed; and in an excited state, visuals emphasizing animation or color are used. In subsequent processing, the analysis results are passed to the visualization unit and presented in an interface optimized for the user's emotional state. As a technical effect, the analysis unit achieves improved user experience, information comprehension, and system flexibility by realizing automatic length control linked to real-time emotion estimation by AI, which differs from conventional uniform analysis result display or manual length adjustment. Specific application fields include dashboard display for messenger applications, trend analysis reports for SNS, progress feedback for online learning, and stress-adaptive response for customer support.

The analysis unit may determine the priority of analysis based on the timing of data collection during analysis. The analysis unit may determine the priority of analysis based on the timing of data collection during analysis, for example. Timing of data collection may include, for example, latest data, past data, and the like, but is not limited to such examples. For example, the analysis unit can prioritize analysis of the latest data. The analysis unit may also refer to past data when analyzing current data. Furthermore, the analysis unit may adjust the order of analysis based on the timing of data collection. Thus, the analysis unit can determine the priority of analysis based on the timing of data collection during analysis, enabling prioritization of analysis for the latest data. Specifically, the analysis unit assigns collection time metadata (e.g., timestamp, collection date, time-series index) to each data item and stores them in a time-series database. The analysis unit is equipped with an analysis queue management module that automatically calculates priority scores based on timing (e.g., high for latest data, low for past data). Examples of input include “Data A: collection time 2024 Jun. 1 12:00, priority 0.95” and “Data B: collection time 2024 May 15 09:30, priority 0.60.” The AI model automatically determines the order of analysis based on the priority score and inputs data to the analysis pipeline starting from the latest data. Furthermore, past data is used as reference data for trend analysis or anomaly detection. Examples of AI model output include “Analysis order: Data A→Data B→Data C” and “Reference data: average value over the past 30 days.” In subsequent processing, the analysis results are passed to the generation unit and visualization unit, enabling real-time information provision and immediate detection of trend changes. As a technical effect, the analysis unit achieves rapid provision of the latest information, immediate response to trend changes, and system-wide efficiency by realizing time-series management and automatic priority control by AI, which differs from conventional uniform analysis order or manual priority setting. Specific application fields include real-time topic analysis for messenger applications, trend alerts for SNS, progress monitoring for online learning, and instant market analysis in marketing.

The analysis unit may adjust the order of analysis based on the relevance of the data during analysis. The analysis unit may adjust the order of analysis based on the relevance of the data during analysis, for example. Relevance of data may include, for example, co-occurrence relationships, correlation relationships, and the like, but is not limited to such examples. For example, the analysis unit can prioritize analysis of highly relevant data. The analysis unit may also postpone analysis of less relevant data. Furthermore, the analysis unit may optimize the order of analysis based on the relevance of the data. Thus, the analysis unit can adjust the order of analysis based on the relevance of the data during analysis, enabling prioritization of analysis for highly relevant data. Specifically, the analysis unit quantifies data relevance by constructing co-occurrence matrices (e.g., co-occurrence count matrix of data ID×data ID), correlation coefficient matrices (e.g., Pearson correlation, Spearman rank correlation), and network graph structures (e.g., edge weights between nodes). Examples of input include “Co-occurrence count between Data A and Data B: 15, correlation coefficient: 0.82” and “Co-occurrence count between Data C and Data D: 2, correlation coefficient: 0.12.” The AI model automatically determines the order of analysis based on relevance scores and inputs highly relevant data to the analysis pipeline first. Examples of AI model output include “Analysis order: Data A→Data B→Data C” and “Related cluster: Data A, Data B.” Furthermore, less relevant data is assigned to batch processing or deferred analysis. In subsequent processing, the analysis results are passed to the generation unit and visualization unit, enabling rankings and displays that reflect topic relevance. As a technical effect, the analysis unit achieves high-precision analysis reflecting topic relationships, improved processing efficiency, and enhanced user experience by realizing automatic order optimization linked to relevance scoring by AI, which differs from conventional uniform analysis order or manual relevance determination. Specific application fields include topic clustering for messenger applications, trend network analysis for SNS, presentation of related teaching materials for online learning, and related product analysis in marketing.

The generation unit can estimate a user's emotion and adjust the criteria for generating rankings based on the estimated emotion of the user. For example, the generation unit estimates the user's emotion and adjusts the criteria for ranking generation based on the estimated emotion. Emotion estimation may include technologies such as facial expression recognition and voice analysis, but is not limited thereto. For instance, when the user is relaxed, the generation unit can generate a detailed ranking. When the user is in a hurry, the generation unit can generate a concise ranking. Furthermore, when the user is excited, the generation unit can generate a visually attractive ranking. Thus, the generation unit can adjust the criteria for ranking generation based on the user's emotion, thereby providing the optimal ranking for the user. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the generation unit receives a user's emotion label (e.g., relaxed, in a hurry, excited, etc.) and a confidence score (e.g., 0.92, etc.) from an emotion estimation module as input, and dynamically controls each processing parameter of the ranking generation pipeline. The generation unit prepares multiple criteria for ranking generation, such as the number of ranking items (e.g., top 3, top 10, all items), the level of detail of the ranking (e.g., word level, topic level, with detailed explanation), and the visual representation of the ranking (e.g., text list, graph, animated word cloud), and automatically selects the optimal combination according to the emotional state. Examples of input to the AI model include “User A: emotion label ‘relaxed’, confidence 0.93” and “User B: emotion label ‘in a hurry’, confidence 0.88”. Examples of output from the AI model include control signals such as “ranking criteria: detailed display, 10 items, with graph” and “ranking criteria: summary display, 3 items, text list only”. Based on these control signals, the generation unit switches the scope of application and output format of the ranking generation algorithm (e.g., TF-IDF score aggregation, co-occurrence network analysis, clustering, etc.). For example, in a relaxed state, the generation unit generates a ranking with detailed explanations and related talk examples for each topic; in a hurried state, it generates a concise ranking by extracting only the main words; and in an excited state, it generates a visually attractive ranking emphasizing colors and animations. As a subsequent process, the generated ranking is passed to the visualization unit and presented to the user in an interface optimized for the user's emotional state. As a technical effect, the generation unit, unlike conventional uniform ranking generation or manual criteria adjustment, realizes automatic criteria optimization linked to real-time emotion estimation by AI, thereby improving user experience, information comprehension, and system flexibility. Specific application fields include emotion-adaptive ranking generation for messenger applications, trend presentation linked to user state in SNS, concentration-adaptive teaching material ranking in online learning, and stress-adaptive FAQ presentation in customer support.

The generation unit can improve the accuracy of generation by considering the interrelationships of data during ranking generation. For example, the generation unit improves the accuracy of generation by considering the interrelationships of data during ranking generation. Data interrelationships may include, for example, co-occurrence relationships and correlation relationships, but are not limited thereto. For instance, the generation unit can analyze the interrelationships of data and preferentially reflect highly relevant data in the ranking. The generation unit can also adjust the ranking order by considering the interrelationships of data. Furthermore, the generation unit can improve the accuracy of the ranking based on the interrelationships of data. Thus, the generation unit can improve the accuracy of generation by considering the interrelationships of data during ranking generation, thereby enhancing the accuracy of the ranking. Specifically, the generation unit constructs a co-occurrence matrix between data (e.g., word-by-word co-occurrence count matrix), a correlation coefficient matrix (e.g., Pearson correlation, Spearman rank correlation, etc.), and a network graph structure (e.g., edge weights between nodes) based on feature vectors and talk content received from the analysis unit. The generation unit applies network centrality indicators (e.g., PageRank, Degree Centrality, Betweenness Centrality, etc.) and clustering algorithms (e.g., k-means, spectral clustering) to these interrelationship data to quantitatively evaluate the relevance between topic words and topics. Examples of input to the AI model include “co-occurrence count between word A and word B: 20, correlation coefficient: 0.85” and “network distance between topic X and topic Y: 2”. Examples of output from the AI model include control signals such as “ranking order adjustment: promote word A to 1st place, word B to 2nd place” and “related cluster: topic X, topic Y, topic Z”. Based on these outputs, the generation unit calculates a composite ranking score that takes into account not only simple occurrence frequency but also relevance scores and network centrality scores, and determines the final ranking order. As a subsequent process, the generated ranking is passed to the visualization unit, and a high-precision ranking reflecting relevance is presented to the user. As a technical effect, the generation unit, unlike conventional simple frequency aggregation or manual ranking adjustment, realizes high-precision ranking generation reflecting topic relevance and trendiness by combining high-dimensional interrelationship analysis by AI and network theory. This achieves improved personalization for each user, increased reliability of rankings, and overall system automation and efficiency. Specific application fields include topic trend analysis for messenger applications, trend network analysis for SNS, related teaching material ranking for online learning, and related product ranking generation in marketing.

The generation unit can perform generation by considering the attribute information of data submitters during ranking generation. For example, the generation unit performs generation by considering the attribute information of data submitters during ranking generation. Attribute information may include, for example, age, gender, occupation, etc., but is not limited thereto. For instance, the generation unit can generate rankings by considering the age group of data submitters. The generation unit can also generate rankings by considering the interests of data submitters. Furthermore, the generation unit can generate rankings by considering the regional information of data submitters. Thus, the generation unit can perform generation by considering the attribute information of data submitters during ranking generation, thereby providing more personalized rankings. Specifically, the generation unit encodes the attribute information of each data submitter (e.g., age, gender, occupation, region, interest tags, etc.) received from the analysis unit using one-hot encoding or embedding vectors, and uses them as weighting parameters for the ranking generation algorithm. The generation unit can branch the ranking generation logic for each attribute, and simultaneously generate rankings by age group, gender, occupation, region, and interests. Examples of input to the AI model include “User A: age 20s, female, student, region Tokyo” and “User B: age 30s, male, company employee, region Osaka”. Examples of output from the AI model include structured data such as “Ranking for women in their 20s: 1st ‘music’, 2nd ‘travel’” and “Ranking for men in their 30s: 1st ‘work’, 2nd ‘gourmet’”. Based on these outputs, the generation unit generates ranking lists optimized for each user attribute and passes them to the visualization unit. As a subsequent process, the visualization unit matches the user's attribute information and presents the most relevant ranking. As a technical effect, the generation unit, unlike conventional overall rankings or manual attribute-based aggregation, realizes automatic integration of multidimensional attribute information and personalized control by AI, thereby improving ranking accuracy, user satisfaction, and system adaptability. Specific application fields include personalized rankings for messenger applications, attribute-based trend presentation for SNS, individually optimized teaching material rankings for online learning, and targeted information provision in marketing.

The generation unit can estimate a user's emotion and adjust the display order of rankings based on the estimated emotion of the user. For example, the generation unit estimates the user's emotion and adjusts the display order of rankings based on the estimated emotion. Emotion estimation may include technologies such as facial expression recognition and voice analysis, but is not limited thereto. For instance, when the user is relaxed, the generation unit can display a detailed ranking. When the user is in a hurry, the generation unit can display a concise ranking. Furthermore, when the user is excited, the generation unit can display a visually attractive ranking. Thus, the generation unit can adjust the display order of rankings based on the user's emotion, thereby providing the optimal display order for the user. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the generation unit receives a user's emotion label (e.g., relaxed, in a hurry, excited, etc.) and a confidence score from an emotion estimation module as input, and executes a ranking display order control algorithm. The generation unit automatically switches the order of ranking items (e.g., by topic importance, trendiness, user interest, visual impact, etc.) and display format (e.g., detailed list, summary list, animated display, etc.) according to the emotional state. Examples of input to the AI model include “User A: emotion label ‘relaxed’, confidence 0.91” and “User B: emotion label ‘in a hurry’, confidence 0.87”. Examples of output from the AI model include control signals such as “display order: by importance, detailed display” and “display order: by summary, concise display”. Based on these control signals, the generation unit rearranges the ranking data and extracts display content to optimize the user experience. As a subsequent process, the generated ranking is passed to the visualization unit and presented to the user in an interface optimized for the user's emotional state. As a technical effect, the generation unit, unlike conventional fixed display orders or manual rearrangement, realizes automatic display order optimization linked to real-time emotion estimation by AI, thereby improving user experience, information comprehension, and system flexibility. Specific application fields include emotion-adaptive ranking display for messenger applications, trend presentation linked to user state in SNS, concentration-adaptive teaching material display in online learning, and stress-adaptive FAQ presentation in customer support.

The generation unit can perform generation by considering the geographic distribution of data during ranking generation. For example, the generation unit performs generation by considering the geographic distribution of data during ranking generation. Geographic distribution may include, for example, region-based data and country-based data, but is not limited thereto. For instance, the generation unit can analyze the geographic distribution of data and generate rankings for each region. The generation unit can also adjust the ranking order by considering the geographic distribution of data. Furthermore, the generation unit can improve the accuracy of the ranking based on the geographic distribution of data. Thus, the generation unit can perform generation by considering the geographic distribution of data during ranking generation, thereby providing region-specific rankings. Specifically, the generation unit utilizes geographic attributes of each data item (e.g., GPS coordinates, region codes, city IDs, country codes, etc.) received from the analysis unit, applies geographic clustering algorithms (e.g., DBSCAN, k-means), and geographic information system APIs to classify users and data into regional clusters. The generation unit aggregates the frequency and trendiness of topic words for each region and generates region-specific rankings. Examples of input to the AI model include “User A: region Chiyoda-ku, Tokyo, utterance word list” and “User B: region Osaka City, utterance word list”. Examples of output from the AI model include structured data such as “Ranking for Chiyoda-ku, Tokyo: 1st ‘event’, 2nd ‘cafe’” and “Ranking for Osaka City: 1st ‘gourmet’, 2nd ‘sightseeing’”. Based on these outputs, the generation unit generates ranking lists optimized for each region and passes them to the visualization unit. As a subsequent process, the visualization unit matches the user's current location or regional attributes and presents region-optimized rankings. As a technical effect, the generation unit, unlike conventional overall rankings or manual region-based aggregation, realizes real-time geographic information analysis and automatic region-specific ranking generation by AI, thereby achieving comprehensive acquisition of highly regional information, improved user experience, and enhanced accuracy of regional marketing. Specific application fields include regional trend analysis for messenger applications, local event information distribution, information recommendation for tourist destinations, and effectiveness measurement of region-limited campaigns.

The generation unit can improve the accuracy of generation by referring to related literature of the data during ranking generation. For example, the generation unit improves the accuracy of generation by referring to related literature of the data during ranking generation. Related literature may include, for example, academic papers and technical reports, but is not limited thereto. For instance, the generation unit can refer to related literature of the data to improve the accuracy of the ranking. The generation unit can also adjust the ranking order based on related literature. Furthermore, the generation unit can improve the accuracy of the ranking by considering related literature. Thus, the generation unit can improve the accuracy of generation by referring to related literature of the data during ranking generation, thereby enhancing the accuracy of the ranking. Specifically, in the ranking generation process, the generation unit searches external literature databases (e.g., academic paper databases, patent databases, technical report repositories, etc.) via API for topic words and topics received from the analysis unit, and obtains metadata (e.g., title, author, publication year, abstract, citation count, etc.) and full text of related literature. The generation unit applies natural language processing algorithms (e.g., BERT-based contextual embedding, TF-IDF scoring, LDA topic extraction, etc.) to the obtained literature data to calculate relevance scores with the ranking target words and topics. Examples of input to the AI model include “topic word: AI ethics, array of related literature titles and abstract texts” and “topic: online education, full text of related papers”. Examples of output from the AI model include structured data such as “relevance score: 0.92, recommended rank: 1st” and “relevance score: 0.75, recommended rank: 3rd”. The generation unit uses these relevance scores as weighting parameters for the ranking generation algorithm, and calculates composite ranking scores reflecting relevance to external literature in addition to simple occurrence frequency and co-occurrence network analysis results. Furthermore, the generation unit can place topic words based on highly reliable literature, considering reliability indicators such as citation count and publication year. As a subsequent process, the generated ranking is passed to the visualization unit, and rankings with related literature information or topic explanations with literature summaries can be presented to the user. As a technical effect, the generation unit, unlike conventional ranking generation using only internal data or manual literature referencing, realizes external knowledge integration and automatic relevance evaluation by AI, thereby greatly improving the reliability, comprehensiveness, and explainability of rankings, increasing the value of information provided to users, and achieving overall system automation and efficiency. Specific application fields include educational support by adding academic evidence to topic rankings in messenger applications, technical trend analysis in SNS, expert information recommendation, related technology trend presentation in R&D, and patent search support.

The visualization unit can estimate a user's emotion and adjust the display method of visualization based on the estimated emotion of the user. For example, the visualization unit estimates the user's emotion and adjusts the display method of visualization based on the estimated emotion. Emotion estimation may include technologies such as facial expression recognition and voice analysis, but is not limited thereto. For instance, when the user is nervous, the visualization unit can provide a simple and highly visible display method. When the user is relaxed, the visualization unit can provide a display method including detailed information. Furthermore, when the user is excited, the visualization unit can provide a visually attractive display method. Thus, the visualization unit can adjust the display method of visualization based on the user's emotion, thereby providing the optimal display method for the user. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the visualization unit is equipped with a multimodal AI model that combines a facial expression recognition module that extracts facial feature points (e.g., eye opening/closing, mouth corner movement, eyebrow shape, etc.) from camera images, a voice analysis module that extracts voice spectral features (e.g., pitch, speech rate, intonation, length of silent intervals, etc.) from microphone input, and a text analysis module that extracts emotion vocabulary frequency and positive/negative scores from utterance text. The visualization unit inputs these features (e.g., facial landmark coordinate arrays, MFCC vectors, emotion vocabulary scores, etc.) as input tensors to the AI model and outputs emotion classification (e.g., nervous, relaxed, excited, etc.). Examples of input include “User A's facial image+voice data+utterance text” and “User B's voice only”. Examples of output from the AI model include structured data such as “estimated emotion: nervous, confidence 0.89”, “estimated emotion: relaxed, confidence 0.93”, and “estimated emotion: excited, confidence 0.85”. The visualization unit automatically switches the visualization display method (e.g., simple text list, detailed report with graphs, visual display emphasizing animation and colors, etc.) according to the estimated emotion. For example, in a nervous state, only the main points are displayed in large text as a bulleted list; in a relaxed state, detailed statistical graphs and topic distribution diagrams are displayed; and in an excited state, interactive visuals and animations are used. As a subsequent process, the visualization result is reflected in the user interface, realizing information presentation optimized for the user's emotional state. As a technical effect, the visualization unit, unlike conventional uniform display or manual screen design, realizes automatic display optimization linked to real-time emotion estimation by AI, thereby improving user experience, information comprehension, and system flexibility. Specific application fields include dashboard display for messenger applications, trend analysis reports for SNS, progress feedback for online learning, and stress-adaptive responses in customer support.

The visualization unit can select the optimal display method by referring to the user's past operation history during visualization display. For example, the visualization unit selects the optimal display method by referring to the user's past operation history during visualization display. Past operation history may include, for example, click history and browsing history, but is not limited thereto. For instance, the visualization unit can preferentially provide display methods that the user has preferred in the past. The visualization unit can also analyze the user's past operation history and propose the optimal display method. Furthermore, the visualization unit can customize the display method based on the user's past operation history. Thus, the visualization unit can select the optimal display method by referring to the user's past operation history during visualization display, thereby providing the optimal display method for the user. Specifically, the visualization unit stores each user's past operation history data (e.g., click event logs, list of browsed page URLs, display format selection history, display time, scroll amount, filter application history, etc.) in a time-series database and extracts these as feature vectors (e.g., display format usage frequency vector, time-of-day operation tendency, past feedback scores, etc.). The visualization unit inputs these features to clustering algorithms (e.g., k-means, hierarchical clustering) and sequence pattern mining (e.g., Apriori algorithm, LSTM-based time-series prediction model) to automatically extract user display method preference patterns. Examples of input to the AI model include “User A's display format selection history for the past 30 days (time-series vector), click count distribution” and “User B's display history with feedback”. Examples of output from the AI model include structured data such as “recommended display method: graph format, reason: high past usage frequency” and “recommended display method: list format, reason: long browsing time”. Based on these outputs, the visualization unit automatically selects the optimal display method during visualization display to optimize the user experience. As a subsequent process, the selected display method is reflected in the user interface, contributing to improved operation efficiency and user satisfaction. As a technical effect, the visualization unit, unlike conventional uniform display or manual customization, realizes automatic optimization by AI through analysis of past history, thereby improving personalization for each user, information acquisition efficiency, and system flexibility. Specific application fields include dashboard display optimization for messenger applications, trend visualization for SNS, progress feedback for online learning, and user-adaptive display for marketing dashboards.

The visualization unit can select the optimal display method by considering the user's device information during visualization display. For example, the visualization unit selects the optimal display method by considering the user's device information during visualization display. Device information may include, for example, device type, screen size, OS, etc., but is not limited thereto. For instance, when the user is using a smartphone, the visualization unit can provide a display method adapted to the screen size. When the user is using a tablet, the visualization unit can provide a display method optimized for a larger screen. Furthermore, when the user is using a smartwatch, the visualization unit can provide a concise and highly visible display method. Thus, the visualization unit can select the optimal display method by considering the user's device information during visualization display, thereby providing the optimal display method for the user. Specifically, the visualization unit obtains device information from the user terminal (e.g., device type, screen resolution, screen size, OS version, input interface type, etc.) in real time and inputs these as feature vectors (e.g., device type one-hot vector, screen size value, OS type embedding vector, etc.) to the AI model. The visualization unit applies display layout optimization algorithms (e.g., decision trees, rule-based classifiers, neural networks, etc.) based on device information to automatically select the optimal display method. Examples of input to the AI model include “device type: smartphone, screen size: 5.5 inches”, “device type: tablet, screen size: 10 inches”, and “device type: smartwatch, screen size: 1.5 inches”. Examples of output from the AI model include control signals such as “recommended display method: vertical scroll list”, “recommended display method: grid format”, and “recommended display method: concise icon display”. Based on these control signals, the visualization unit automatically adjusts the display layout, font size, button arrangement, and interaction method for rankings and trend information. As a subsequent process, the optimized display method is reflected in the user interface, contributing to improved user experience and information acquisition efficiency. As a technical effect, the visualization unit, unlike conventional fixed screen design or manual device adaptation, realizes real-time device information analysis and automatic layout optimization by AI, thereby improving flexibility for multi-device support, user satisfaction, and system maintainability. Specific application fields include multi-device compatible UI for messenger applications, responsive design for SNS, device-optimized display for online learning platforms, and information presentation for wearable devices.

The visualization unit can estimate a user's emotion and adjust the operation procedure of visualization based on the estimated emotion of the user. For example, the visualization unit estimates the user's emotion and adjusts the operation procedure of visualization based on the estimated emotion. Emotion estimation may include technologies such as facial expression recognition and voice analysis, but is not limited thereto. For instance, when the user is nervous, the visualization unit can provide a simple and intuitive operation procedure. When the user is relaxed, the visualization unit can provide a detailed operation procedure. Furthermore, when the user is excited, the visualization unit can provide a visually attractive operation procedure. Thus, the visualization unit can adjust the operation procedure of visualization based on the user's emotion, thereby providing the optimal operation procedure for the user. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the visualization unit is equipped with a multimodal AI model that combines a facial expression recognition module (e.g., feature point extraction from facial images), a voice analysis module (e.g., emotion feature extraction from voice waveforms), and a text analysis module (e.g., emotion vocabulary extraction from utterance content). The visualization unit inputs these features (e.g., facial landmark coordinates, MFCC vectors, emotion vocabulary scores, etc.) as input tensors to the AI model and outputs emotion classification (e.g., nervous, relaxed, excited, etc.). Examples of input include “User A's facial image+voice data+utterance text” and “User B's voice only”. Examples of output from the AI model include structured data such as “estimated emotion: nervous, confidence 0.90” and “estimated emotion: relaxed, confidence 0.88”. The visualization unit automatically switches the operation procedure of visualization (e.g., simple one-tap operation, detailed guided operation, interaction emphasizing animation and colors, etc.) according to the estimated emotion. For example, in a nervous state, only the main functions are presented with large buttons; in a relaxed state, detailed help and tutorials are displayed; and in an excited state, interactive animations and gamification elements are added. As a subsequent process, the operation procedure is reflected in the user interface, realizing an operation experience optimized for the user's emotional state. As a technical effect, the visualization unit, unlike conventional uniform operation design or manual procedure adjustment, realizes automatic operation procedure optimization linked to real-time emotion estimation by AI, thereby improving user experience, reducing operation errors, and enhancing system flexibility. Specific application fields include emotion-adaptive UI for messenger applications, interaction optimization for SNS, operation guide presentation for online learning, and stress-adaptive navigation in customer support.

The visualization unit can select the optimal display method by considering the user's interests during visualization display. For example, the visualization unit selects the optimal display method by considering the user's interests during visualization display. Interests may include, for example, hobbies and topics of interest, but are not limited thereto. For instance, the visualization unit can preferentially display relevant information based on the user's interests. The visualization unit can also analyze the user's interests and propose the optimal display method. Furthermore, the visualization unit can customize the display method based on the user's interests. Thus, the visualization unit can select the optimal display method by considering the user's interests during visualization display, thereby providing the optimal display method for the user. Specifically, the visualization unit obtains interest information registered by the user or extracted from operation history (e.g., hobby tags, topics of interest, previously browsed words, followed categories, etc.) from the database, encodes these using one-hot encoding or embedding vectors, and inputs them to the AI model. Examples of input include multidimensional feature vectors such as “User A: hobby tags=music, movies; previously browsed topics=live events, new movies” and “User B: topics of interest=gourmet, travel; followed categories=cafes, tourist spots”. The visualization unit applies recommendation algorithms (e.g., collaborative filtering, content-based recommendation, clustering) and display layout optimization algorithms (e.g., decision trees, neural networks) based on these features to automatically select the priority display of information most relevant to the user's interests and the display format (e.g., graph, word cloud, list, card-type UI, etc.). Examples of output from the AI model include control signals such as “recommended display method: place music topic in graph format at the top”, “recommended display method: emphasize gourmet-related ranking in card format”, and “recommended display method: visualize travel topic in word cloud”. Based on these outputs, the visualization unit automatically adjusts the display order, highlight colors, layout structure, and interaction method (e.g., tap for details, swipe to switch categories, etc.) for rankings and trend information. As a subsequent process, feedback from user operations on the display content (e.g., number of clicks, display time, number of detail views, etc.) is continuously collected and used for retraining the interest model and display optimization. As a technical effect, the visualization unit, unlike conventional static screen design or manual interest estimation, realizes improved personalization for each user, information acquisition efficiency, and system flexibility and scalability by combining multidimensional feature analysis and automatic layout optimization by AI. Specific application fields include personalized dashboards for messenger applications, interest-based trend visualization for SNS, presentation of topics of interest for online learning platforms, and user-adaptive display for marketing dashboards.

The visualization unit can improve the display method by reflecting user feedback during visualization display. For example, the visualization unit improves the display method by reflecting user feedback during visualization display. Feedback may include, for example, user ratings and comments, but is not limited thereto. For instance, the visualization unit can improve the display method based on user feedback. The visualization unit can also analyze user feedback and propose the optimal display method. Furthermore, the visualization unit can customize the display method by reflecting user feedback. Thus, the visualization unit can improve the display method by reflecting user feedback during visualization display, thereby providing the optimal display method for the user. Specifically, the visualization unit collects user feedback performed on the display screen (e.g., rating scores for display formats, comment input, customization operations for display content, survey responses, frequency of UI element usage, etc.) in real time and stores them in a time-series database. Examples of input include multidimensional feedback data such as “User A: 5-star rating for graph display, comment ‘easy to see’”, “User B: 3-star rating for list display, comment ‘too many items’”, and “User C: frequent use of card-type UI”. The visualization unit vectorizes these feedback data and inputs them to an AI model (e.g., supervised learning-based display format optimization model, reinforcement learning-based UI improvement model, etc.). The AI model analyzes feedback tendencies for each user and the overall rating distribution, and outputs the optimal display method (e.g., graph format, list format, card-type UI, word cloud, etc.), display content priority, and layout improvement proposals. Examples of output from the AI model include control signals such as “recommended display method: graph format, reason: many high ratings”, “recommended display method: list format, reason: many requests for more items in comments”, and “recommended display method: card-type UI, reason: high usage frequency”. Based on these outputs, the visualization unit automatically adjusts the display layout, UI element arrangement, highlight display, and interaction method to continuously optimize the user experience. As a subsequent process, new feedback on the improved display method is collected, and the AI model is retrained and A/B testing is conducted to verify effectiveness. As a technical effect, the visualization unit, unlike conventional static screen design or manual feedback reflection, realizes real-time feedback analysis and automatic UI optimization by AI, thereby achieving continuous improvement of user satisfaction, information acquisition efficiency, and system flexibility and maintainability. Specific application fields include dashboard display optimization for messenger applications, trend visualization for SNS, progress feedback for online learning, and user-adaptive display for marketing dashboards.

The estimation unit can estimate a user's emotion and improve the accuracy of age group estimation based on the estimated emotion of the user. For example, the estimation unit estimates the user's emotion and improves the accuracy of age group estimation based on the estimated emotion. Emotion estimation may include technologies such as facial expression recognition and voice analysis, but is not limited thereto. For instance, when the user is relaxed, the estimation unit can estimate the age group based on detailed information. When the user is in a hurry, the estimation unit can estimate the age group based on concise information. Furthermore, when the user is excited, the estimation unit can estimate the age group based on visually attractive information. Thus, the estimation unit can improve the accuracy of age group estimation based on the user's emotion, thereby performing more accurate age group estimation. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the estimation unit is equipped with a multimodal AI model that combines a facial expression recognition module (e.g., extraction of facial feature points from facial images), a voice analysis module (e.g., extraction of MFCC and pitch features from voice waveforms), and a speech text analysis module (e.g., emotion vocabulary scoring). The estimation unit inputs these features (e.g., facial landmark coordinate arrays, voice spectral vectors, emotion vocabulary frequency vectors, etc.) as input tensors to the AI model and outputs emotion classification (e.g., relaxed, in a hurry, excited, etc.). Examples of input include “User A's facial image+voice data+speech text” and “User B's voice only”. Examples of output from the AI model include structured data such as “estimated emotion: relaxed, confidence 0.91” and “estimated emotion: in a hurry, confidence 0.88”. The estimation unit automatically switches the amount of input information and analysis detail (e.g., use of detailed features, use of summary features, emphasis on visual features, etc.) of the age group estimation algorithm according to the estimated emotion. For example, in a relaxed state, detailed behavioral history and speech content are used as multidimensional feature vectors; in a hurried state, only main features are extracted for fast estimation; and in an excited state, visually emphasized information (e.g., input data with colors and animations) is utilized. As a subsequent process, the age group estimation result is passed to the visualization unit or analysis unit, contributing to optimization of user experience and system efficiency. As a technical effect, the estimation unit, unlike conventional uniform age group estimation or manual adjustment of analysis detail, realizes automatic optimization of estimation accuracy linked to real-time emotion estimation by AI, thereby improving estimation accuracy, optimizing computational resources, and enhancing user experience. Specific application fields include age group estimation for messenger applications, user attribute estimation for SNS, individual optimization for online learning, and target group estimation in marketing.

The estimation unit can optimize the estimation algorithm by referring to the user's past behavior data during age group estimation. For example, the estimation unit optimizes the estimation algorithm by referring to the user's past behavior data during age group estimation. Past behavior data may include, for example, browsing history and purchase history, but is not limited thereto. For instance, the estimation unit can optimize the age group estimation algorithm based on the user's past behavior data. The estimation unit can also analyze the user's past behavior patterns to improve the accuracy of age group estimation. Furthermore, the estimation unit can adjust the age group estimation algorithm by referring to the user's past behavior data. Thus, the estimation unit can optimize the estimation algorithm by referring to the user's past behavior data during age group estimation, thereby improving the accuracy of age group estimation. Specifically, the estimation unit stores each user's past behavior data (e.g., click event logs, list of browsed page URLs, purchase history tables, array of talk history texts, etc.) in a time-series database and extracts these as feature vectors (e.g., function usage frequency vector, activity distribution by time, number of purchases by category, etc.). The estimation unit inputs these features to clustering algorithms (e.g., k-means, hierarchical clustering) and sequence pattern mining (e.g., Apriori algorithm, LSTM-based time-series prediction model) to automatically extract user behavior patterns. Examples of input to the AI model include “User A's click history for the past 30 days (time-series vector), distribution of browsed page categories” and “User B's purchase history (array of product IDs, purchase times)”. Examples of output from the AI model include structured data such as “estimated age group: 20s, confidence 0.87” and “estimated age group: 30s, confidence 0.92”. Based on these outputs, the estimation unit automatically optimizes parameters (e.g., feature selection, weighting, model branching) of the age group estimation algorithm. As a subsequent process, the optimized estimation result is passed to the analysis unit or visualization unit, contributing to improved user experience and system efficiency. As a technical effect, the estimation unit, unlike conventional uniform age group estimation or manual pattern analysis, realizes automatic estimation optimization linked to AI-based past behavior analysis, thereby improving estimation accuracy, reducing unnecessary data, and efficiently utilizing system resources. Specific application fields include age group estimation for messenger applications, user attribute estimation for e-commerce sites, individual optimization based on learning history for online learning, and user attribute estimation for IoT devices.

The estimation unit can perform estimation by considering the user's profile information during age group estimation. For example, the estimation unit performs estimation by considering the user's profile information during age group estimation. Profile information may include, for example, age, gender, occupation, etc., but is not limited thereto. For instance, the estimation unit can estimate the age group based on the user's profile information. The estimation unit can also analyze the user's profile information to improve the accuracy of age group estimation. Furthermore, the estimation unit can adjust the age group estimation algorithm by referring to the user's profile information. Thus, the estimation unit can perform estimation by considering the user's profile information during age group estimation, thereby improving the accuracy of age group estimation. Specifically, the estimation unit encodes the profile information registered by the user (e.g., age, gender, occupation, region, interest tags, etc.) using one-hot encoding or embedding vectors and uses them as input features for the age group estimation algorithm. Examples of input include multidimensional feature vectors such as “User A: age not registered, female, student, interest tags=music, movies” and “User B: age not registered, male, company employee, interest tags=gourmet, travel”. The estimation unit applies classification algorithms (e.g., decision trees, random forests, neural networks, etc.) based on these features to estimate the age group from the combination of profile information and behavior data. Examples of output from the AI model include structured data such as “estimated age group: 20s, confidence 0.89” and “estimated age group: 30s, confidence 0.93”. The estimation unit automatically adjusts the weighting and branching control of the estimation algorithm according to the presence or absence and reliability of profile information. As a subsequent process, the estimation result is passed to the analysis unit or visualization unit, contributing to improved user experience and system efficiency. As a technical effect, the estimation unit, unlike conventional simple estimation using only profile information or manual attribute determination, realizes automatic estimation optimization by AI through integration of multidimensional attributes, thereby improving estimation accuracy, user satisfaction, and system adaptability. Specific application fields include age group estimation for messenger applications, user attribute estimation for SNS, individual optimization for online learning, and target group estimation in marketing.

The estimation unit can estimate a user's emotion and adjust the display method of estimation results based on the estimated emotion of the user. For example, the estimation unit estimates the user's emotion and adjusts the display method of estimation results based on the estimated emotion. Emotion estimation may include technologies such as facial expression recognition and voice analysis, but is not limited thereto. For instance, when the user is nervous, the estimation unit can provide a simple and highly visible display method. When the user is relaxed, the estimation unit can provide a display method including detailed information. Furthermore, when the user is excited, the estimation unit can provide a visually attractive display method. Thus, the estimation unit can adjust the display method of estimation results based on the user's emotion, thereby providing the optimal display method for the user. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the estimation unit is equipped with a multimodal AI model that combines a facial expression recognition module (e.g., feature point extraction from facial images), a voice analysis module (e.g., emotion feature extraction from voice waveforms), and a text analysis module (e.g., emotion vocabulary extraction from utterance content). The estimation unit inputs these features (e.g., facial landmark coordinates, MFCC vectors, emotion vocabulary scores, etc.) as input tensors to the AI model and outputs emotion classification (e.g., nervous, relaxed, excited, etc.). Examples of input include “User A's facial image+voice data+utterance text” and “User B's voice only”. Examples of output from the AI model include structured data such as “estimated emotion: nervous, confidence 0.90” and “estimated emotion: relaxed, confidence 0.88”. The estimation unit automatically switches the display method of estimation results (e.g., simple text display, detailed report with graphs, visual display emphasizing animation and colors, etc.) according to the estimated emotion. For example, in a nervous state, only the main points are displayed in large text as a bulleted list; in a relaxed state, detailed statistical graphs and topic distribution diagrams are displayed; and in an excited state, interactive visuals and animations are used. As a subsequent process, the estimation result is passed to the visualization unit and presented to the user in an interface optimized for the user's emotional state. As a technical effect, the estimation unit, unlike conventional uniform display or manual screen design, realizes automatic display optimization linked to real-time emotion estimation by AI, thereby improving user experience, information comprehension, and system flexibility. Specific application fields include display of age group estimation results for messenger applications, user attribute presentation for SNS, progress feedback for online learning, and stress-adaptive responses in customer support.

The estimation unit can perform estimation by considering the user's geographic location information during age group estimation. For example, the estimation unit performs estimation by considering the user's geographic location information during age group estimation. Geographic location information may include, for example, GPS data and location information services, but is not limited thereto. For instance, the estimation unit can estimate the age group based on the user's geographic location information. The estimation unit can also analyze the user's geographic location information to improve the accuracy of age group estimation. Furthermore, the estimation unit can adjust the age group estimation algorithm by referring to the user's geographic location information. Thus, the estimation unit can perform estimation by considering the user's geographic location information during age group estimation, thereby improving the accuracy of age group estimation. Specifically, the estimation unit obtains GPS coordinates and Wi-Fi/Bluetooth-based location information from the user terminal in real time and generates geographic feature vectors (e.g., latitude/longitude, region code, city/prefecture ID, etc.). The estimation unit utilizes these location information to apply geographic clustering algorithms (e.g., DBSCAN, k-means) and geographic information system APIs to identify the regional cluster to which the user currently belongs. Examples of input include “User A: latitude 35.68, longitude 139.76 (Chiyoda-ku, Tokyo)” and “User B: latitude 34.69, longitude 135.50 (Osaka City)”. The estimation unit refers to a database of age group distribution by region and region-specific behavior patterns, and uses geographic attributes as weighting parameters for the age group estimation algorithm. Examples of output from the AI model include structured data such as “estimated age group: 20s, confidence 0.90 (Chiyoda-ku, Tokyo)” and “estimated age group: 30s, confidence 0.88 (Osaka City)”. Based on these outputs, the estimation unit automatically applies age group estimation logic optimized for each region. As a subsequent process, the estimation result is passed to the analysis unit or visualization unit and utilized for region-specific information presentation and marketing measures. As a technical effect, the estimation unit, unlike conventional overall estimation or manual region determination, realizes real-time geographic information analysis and automatic region-specific estimation by AI, thereby achieving highly regional age group estimation, improved user experience, and enhanced accuracy of regional marketing. Specific application fields include region-based age group estimation for messenger applications, local event information distribution, user attribute estimation for tourist destinations, and effectiveness measurement of region-limited campaigns.

The estimation unit can improve the accuracy of estimation by analyzing the user's social media activity during age group estimation. For example, the estimation unit improves the accuracy of estimation by analyzing the user's social media activity during age group estimation. Social media activity may include, for example, post content, number of likes, number of followers, etc., but is not limited thereto. For instance, the estimation unit can estimate the age group based on the user's social media activity. The estimation unit can also analyze the user's social media activity to improve the accuracy of age group estimation. Furthermore, the estimation unit can adjust the age group estimation algorithm by referring to the user's social media activity. Thus, the estimation unit can improve the accuracy of estimation by analyzing the user's social media activity during age group estimation, thereby improving the accuracy of age group estimation. Specifically, the estimation unit obtains multidimensional information such as post text, post time, tags and hashtags attached to posts, number of likes, number of shares, number of comments, number of followers, follow relationship graphs, groups and event information the user participates in, etc., as social media activity data via API or scraping technology. The estimation unit structures these data as multidimensional tensors of user ID×time×post content×metadata and stores them in a database. Furthermore, the estimation unit collects metadata of URLs, images, and videos shared by the user and uses them as features for analyzing relevance to external content. Examples of input to the AI model include “User A's post text array for the past 30 days, time series of likes, shares, comments for each post, time series of number of followers” and “User B's follow relationship graph, list of participating groups, array of hashtags attached to posts”. The AI model receives these multidimensional features as input tensors and combines natural language processing algorithms (e.g., BERT-based contextual embedding, LDA topic extraction), social graph analysis by graph neural networks, and time series analysis (e.g., LSTM) to estimate the user's age group. Examples of output from the AI model include structured data such as “estimated age group: 20s, confidence 0.85” and “estimated age group: 30s, confidence 0.90”. Based on these outputs, the estimation unit automatically optimizes parameters (e.g., feature selection, weighting, model branching) of the age group estimation algorithm. As a subsequent process, the estimation result is passed to the analysis unit or visualization unit, contributing to improved user experience and system efficiency. As a technical effect, the estimation unit, unlike conventional simple post history collection or manual age group estimation, realizes improved estimation accuracy, increased personalization for each user, and overall system automation and efficiency by combining multidimensional feature analysis and social graph analysis by AI. Specific application fields include age group estimation for messenger applications, user attribute estimation for SNS, target user extraction in marketing, health monitoring of online communities, and effectiveness measurement of event promotion.

The analysis unit using natural language processing technology can estimate a user's emotion and adjust the analysis method of natural language processing based on the estimated emotion of the user. For example, the analysis unit using natural language processing technology estimates the user's emotion and adjusts the analysis method of natural language processing based on the estimated emotion. Emotion estimation may include technologies such as facial expression recognition and voice analysis, but is not limited thereto. For instance, when the user is relaxed, the analysis unit using natural language processing technology can perform detailed analysis. When the user is in a hurry, the analysis unit can perform concise analysis. Furthermore, when the user is excited, the analysis unit can perform visually attractive analysis. Thus, the analysis unit using natural language processing technology can adjust the analysis method of natural language processing based on the user's emotion, thereby providing the optimal analysis result for the user. Emotion estimation is realized, for example, by using an emotion engine or a generative AI with emotion estimation functionality. The generative AI may be, for example, a text generation AI (such as an LLM) or a multimodal generative AI, but is not limited thereto. Specifically, the analysis unit is equipped with a multimodal AI model that combines a facial expression recognition module (e.g., feature point extraction from facial images), a voice analysis module (e.g., emotion feature extraction from voice waveforms), and a text analysis module (e.g., emotion vocabulary extraction from utterance content). The analysis unit inputs these features (e.g., facial landmark coordinates, MFCC vectors, emotion vocabulary scores, etc.) as input tensors to the AI model and outputs emotion classification (e.g., relaxed, in a hurry, excited, etc.). Examples of input include “User A's facial image +voice data+utterance text” and “User B's voice only”. Examples of output from the AI model include structured data such as “estimated emotion: relaxed, confidence 0.91” and “estimated emotion: in a hurry, confidence 0.88”. The analysis unit automatically switches the analysis method of natural language processing (e.g., detailed context analysis, summary analysis, analysis with visual emphasis, etc.) according to the estimated emotion. For example, in a relaxed state, detailed topic distribution and relationship analysis are performed; in a hurried state, only main keyword extraction and summarization are performed; and in an excited state, analysis results emphasizing animation and colors are generated. As a subsequent process, the analysis result is passed to the visualization unit and presented to the user in an interface optimized for the user's emotional state. As a technical effect, the analysis unit, unlike conventional uniform analysis processing or manual adjustment of analysis detail, realizes automatic optimization of analysis method linked to real-time emotion estimation by AI, thereby improving user experience, information comprehension, and system flexibility. Specific application fields include talk content analysis for messenger applications, trend analysis for SNS, progress analysis for online learning, and stress-adaptive responses in customer support.

The analysis unit using natural language processing technology can adjust the level of detail of analysis based on the importance of the data during natural language processing. For example, the analysis unit using natural language processing technology adjusts the level of detail of analysis based on the importance of the data during natural language processing. Importance of data may include, for example, occurrence frequency and user interest, but is not limited thereto. For instance, the analysis unit using natural language processing technology can perform detailed analysis for highly important data. The analysis unit can also perform simplified analysis for less important data. Furthermore, the analysis unit can perform moderately detailed analysis for data of medium importance. Thus, the analysis unit using natural language processing technology can adjust the level of detail of analysis based on the importance of the data during natural language processing, thereby performing detailed analysis for important data. Specifically, the analysis unit quantitatively evaluates the importance of each data item by calculating features such as occurrence frequency score, user interest score (e.g., number of clicks, browsing time, number of likes, etc.), and topic trendiness score (e.g., increase rate over the past 7 days). These features are input to the AI model as feature vectors (e.g., data ID×feature dimension). The AI model controls branching of the analysis pipeline based on the importance score. Examples of input include “Data A: occurrence frequency 0.95, interest 0.88, trendiness 0.91” and “Data B: occurrence frequency 0.32, interest 0.21, trendiness 0.15”. Examples of output from the AI model include control signals such as “analysis detail: high (detailed analysis applied)” and “analysis detail: low (summary analysis applied)”. When the detail is high, the analysis unit applies natural language processing algorithms (e.g., BERT-based contextual embedding, LDA topic distribution estimation, co-occurrence network analysis, etc.) in multiple stages to perform detailed topic extraction and relationship analysis. When the detail is low, only simple frequency aggregation or keyword extraction is performed. As a subsequent process, the analysis result is passed to the generation unit or visualization unit and presented to the user at the optimal information granularity. As a technical effect, the analysis unit, unlike conventional uniform analysis processing or manual adjustment of analysis detail, realizes automatic control of analysis detail linked to importance evaluation by AI, thereby optimizing computational resources, concentrating analysis resources on important data, and improving user experience. Specific application fields include topic ranking generation for messenger applications, trend analysis for SNS, extraction of important points for online learning, and analysis of popular products in marketing.

The analysis unit using natural language processing technology can apply different analysis algorithms according to the category of data during natural language processing. For example, the analysis unit using natural language processing technology applies different analysis algorithms according to the category of data during natural language processing. Data categories may include, for example, text data, image data, audio data, and the like, but are not limited thereto. For example, the analysis unit using natural language processing technology can apply natural language processing algorithms to text data. The analysis unit using natural language processing technology can also apply image analysis algorithms to image data. Furthermore, the analysis unit using natural language processing technology can apply audio analysis algorithms to audio data. Thus, the analysis unit using natural language processing technology can apply different analysis algorithms according to the category of data during natural language processing. As a result, the analysis unit using natural language processing technology can perform optimal analysis according to the characteristics of the data. Specifically, the analysis unit is equipped with a data category determination module that automatically determines the category of input data, such as text, image, or audio, based on metadata (e.g., file extension, MIME type, data structure) and content features (e.g., text length, image resolution, audio sample rate, etc.). Examples of input include “Data A: Text (UTF-8), length 120 characters”, “Data B: Image (JPEG), resolution 640×480”, “Data C: Audio (WAV), sample rate 16 kHz”, and so on. For text data, the analysis unit applies natural language processing algorithms such as morphological analysis, BERT-based contextual embedding, and topic extraction by LDA; for image data, it applies image feature extraction, object detection, and image classification using convolutional neural networks (CNN); and for audio data, it applies audio analysis algorithms such as MFCC extraction, speech recognition, and emotion classification. Examples of AI model outputs include structured data such as “Data A: Main topic ‘Travel’, topic distribution [0.7,0.2,0.1]”, “Data B: Detected object ‘Cafe’, confidence 0.93”, “Data C: Estimated emotion ‘Relaxed’, confidence 0.89”. In subsequent processing, the analysis results are passed to the generation unit and visualization unit, enabling optimized ranking and display for each category. As a technical effect, the analysis unit achieves improved analysis accuracy, faster processing speed, and enhanced system flexibility by realizing automatic category determination and optimal algorithm selection by AI, which differs from conventional uniform application of analysis algorithms and manual data classification. Specific application fields include multimedia analysis for messenger applications, image and audio trend analysis for SNS, automatic classification of educational materials for online learning, and multimodal response for customer support.

The analysis unit using natural language processing technology can estimate a user's emotion and adjust the order of displaying natural language processing analysis results based on the estimated emotion of the user. For example, the analysis unit using natural language processing technology estimates a user's emotion and adjusts the order of displaying natural language processing analysis results based on the estimated emotion. Emotion estimation may include, for example, technologies such as facial expression recognition and audio analysis, but is not limited thereto. For example, if the user is relaxed, the analysis unit using natural language processing technology can display detailed analysis results. If the user is in a hurry, it can display concise analysis results. Furthermore, if the user is excited, it can display visually attractive analysis results. Thus, the analysis unit using natural language processing technology can adjust the order of displaying natural language processing analysis results based on the user's emotion, thereby providing the optimal display order for the user. Emotion estimation is realized, for example, by using an emotion engine or generative AI with emotion estimation functions. Generative AI may include, for example, text generation AI (such as LLM) or multimodal generative AI, but is not limited thereto. Specifically, the analysis unit is equipped with a multimodal AI model that combines a facial expression recognition module (e.g., feature point extraction from facial images), an audio analysis module (e.g., extraction of emotional features from audio waveforms), and a text analysis module (e.g., extraction of emotional vocabulary from utterance content) for user emotion estimation. The analysis unit inputs these features (e.g., facial landmark coordinates, MFCC vectors, emotional vocabulary scores) as input tensors to the AI model, which outputs emotion classification (e.g., relaxed, in a hurry, excited, etc.). Examples of input include “User A's facial image+audio data+utterance text”, “User B's audio only”, and so on. Examples of AI model outputs include structured data such as “Estimated emotion: Relaxed, confidence 0.91”, “Estimated emotion: In a hurry, confidence 0.88”. The analysis unit automatically switches the display order of analysis results according to the estimated emotion (e.g., displaying detailed analysis results at the top, summary results at the beginning, prioritizing visually emphasized results, etc.). For example, in a relaxed state, detailed analysis results are displayed at the top; in a hurried state, only key points are displayed first; and in an excited state, results with animation or enhanced colors are prioritized. In subsequent processing, the analysis results are passed to the visualization unit and presented in an interface optimized for the user's emotional state. As a technical effect, the analysis unit achieves improved user experience, enhanced information comprehension, and increased system flexibility by realizing automatic display order optimization linked to real-time emotion estimation by AI, which differs from conventional fixed display order and manual sorting. Specific application fields include talk content analysis for messenger applications, trend analysis for SNS, progress analysis for online learning, and stress-adaptive response for customer support.

The analysis unit using natural language processing technology can determine the priority of analysis based on the timing of data collection during natural language processing. For example, the analysis unit using natural language processing technology determines the priority of analysis based on the timing of data collection during natural language processing. The timing of data collection may include, for example, latest data, past data, and the like, but is not limited thereto. For example, the analysis unit using natural language processing technology can prioritize the analysis of the latest data. It can also analyze current data with reference to past data. Furthermore, it can adjust the order of analysis based on the timing of data collection. Thus, the analysis unit using natural language processing technology can determine the priority of analysis based on the timing of data collection during natural language processing, thereby prioritizing the analysis of the latest data. Specifically, the analysis unit attaches collection time metadata (e.g., timestamp, collection date, time series index, etc.) to each data item and stores it in a time series database. The analysis unit is equipped with a queue management module that automatically calculates priority scores based on the timing of collection (e.g., high for latest data, low for past data). Examples of input include “Data A: Collection time 2024 Jun. 1 12:00, priority 0.95”, “Data B: Collection time 2024 May 15 09:30, priority 0.60”, and so on. The AI model automatically determines the analysis order based on the priority score and feeds data into the analysis pipeline in order from the latest data. Furthermore, past data is used as reference data for trend analysis and anomaly detection. Examples of AI model outputs include “Analysis order: Data A→Data B→Data C”, “Reference data: average value for the past 30 days”, and so on. In subsequent processing, the analysis results are passed to the generation unit and visualization unit, enabling real-time information provision and immediate detection of trend changes. As a technical effect, the analysis unit achieves rapid provision of the latest information, immediate response to trend changes, and overall system efficiency by realizing time series management and automatic priority control by AI, which differs from conventional uniform analysis order and manual priority setting. Specific application fields include real-time topic analysis for messenger applications, trend alerts for SNS, progress monitoring for online learning, and instant market analysis in marketing.

The analysis unit using natural language processing technology can improve the accuracy of analysis by referring to related literature during natural language processing. For example, the analysis unit using natural language processing technology improves the accuracy of analysis by referring to related literature during natural language processing. Related literature may include, for example, academic papers, technical reports, and the like, but is not limited thereto. For example, the analysis unit using natural language processing technology can refer to related literature to improve the accuracy of analysis. It can also adjust the order of analysis based on related literature. Furthermore, it can improve the accuracy of analysis by considering related literature. Thus, the analysis unit using natural language processing technology can improve the accuracy of analysis by referring to related literature during natural language processing. Specifically, the analysis unit searches external literature databases related to the topic words or topics to be analyzed (e.g., academic paper databases, patent databases, technical report repositories, etc.) via API, and obtains metadata (e.g., title, author, publication year, abstract, citation count, etc.) and full text of related literature. The analysis unit applies natural language processing algorithms (e.g., BERT-based contextual embedding, TF-IDF scoring, topic extraction by LDA, etc.) to the obtained literature data and calculates relevance scores with the topic words or topics to be analyzed. Examples of AI model input include “Topic word: AI ethics, array of related literature titles and abstract texts”, “Topic: online education, full text of related papers”, and so on. Examples of AI model output include structured data such as “Relevance score: 0.92, recommended analysis order: 1st”, “Relevance score: 0.75, recommended analysis order: 3rd”, and so on. The analysis unit uses these relevance scores as weighting parameters for the analysis algorithms, realizing high-precision analysis that integrates not only internal data but also external knowledge. Furthermore, reliability indicators such as citation count and publication year of related literature are considered, and analysis results based on highly reliable literature can be preferentially presented. In subsequent processing, the analysis results are passed to the generation unit and visualization unit, and it is possible to present analysis results with related literature information or topic explanations with literature summaries to users. As a technical effect, the analysis unit achieves significant improvement in reliability, coverage, and explainability of analysis, increased value of information provision to users, and overall system automation and efficiency by realizing external knowledge integration and automatic relevance evaluation by AI, which differs from conventional analysis using only internal data and manual literature reference. Specific application fields include educational support by providing academic evidence for topic analysis in messenger applications, technical trend analysis for SNS, information recommendation for experts, presentation of related technology trends in research and development, and patent search support.

The system according to the embodiment is not limited to the examples described above and can be variously modified as follows, for example. Specifically, the system can realize various variations from a technical perspective, such as the architecture and learning methods of AI models, data flow, input/output specifications, user interface design, network configuration, database structure, security control, and addition of extension modules. The system can perform not only inference by a single large language model, but also multimodal inference by linking multiple AI models (e.g., natural language processing models, image analysis models, speech recognition models, recommendation systems, etc.), parallel processing on distributed clusters, lightweight inference on edge devices, and large-scale data analysis through cloud collaboration. Furthermore, various implementation forms in line with advances in modern computer technology are conceivable, such as personalized control according to user attributes and usage status, real-time data stream processing, anomaly detection and security monitoring, function expansion through external API integration, and anonymization/encryption processing for privacy protection. As a result, the system is not limited to specific application areas or user groups and can be applied in a wide range of fields, including messenger applications, SNS, online learning, marketing, IoT, healthcare, finance, and government. As a technical effect, the system achieves improved user experience, reduced operational costs, and significant improvement in system flexibility, maintainability, and scalability by realizing highly automated, optimized, and extensible system design by AI, which differs from conventional single-function systems and manual operation.

The collection unit can adjust the frequency of data collection according to the battery level of the user's device when collecting user behavior data. For example, when the battery level is low, the frequency of data collection can be reduced to suppress battery consumption. When the battery level is sufficient, more detailed data can be collected. Furthermore, when the battery level is moderate, data collection can be performed at an appropriate frequency. Thus, the collection unit can adjust the frequency of data collection according to the battery level of the user's device. Specifically, the collection unit acquires battery level information (e.g., percentage value, estimated remaining operating time, etc.) from the user terminal in real time and inputs it as a feature vector to the AI model. Examples of input include numerical data such as “Battery level: 15%”, “Battery level: 80%”, “Battery level: 50%”. The collection unit applies control algorithms (e.g., threshold determination, rule-based control, reinforcement learning, etc.) that automatically switch data collection frequency parameters (e.g., 1-minute intervals, 10-minute intervals, 30-minute intervals, etc.) and data granularity (e.g., detailed logs, summary logs, important events only, etc.) according to battery level. Examples of AI model output include control signals such as “Collection frequency: 30-minute intervals (battery level 15%)”, “Collection frequency: 1-minute intervals (battery level 80%)”, “Collection frequency: 10-minute intervals (battery level 50%)”. The collection unit automatically adjusts the operation of the data collection module scheduler and network communication module based on these control signals. In subsequent processing, optimization of battery consumption and balance control of data collection quality are realized, contributing to improved user experience and extended device life. As a technical effect, the collection unit achieves efficient use of device resources, suppression of battery consumption, and improved system flexibility by realizing real-time battery information analysis and automatic collection frequency optimization by AI, which differs from conventional fixed-interval collection and manual frequency adjustment. Specific application fields include power-saving data collection for messenger applications, battery optimization for wearable devices, long-term operation control for IoT devices, and improved user experience for mobile applications.

The analysis unit can adjust the timing of analysis according to the user's internet connection status when analyzing user behavior data. For example, if the internet connection is unstable, analysis can be temporarily suspended and resumed when the connection becomes stable. If the internet connection is stable, real-time analysis can be performed. Furthermore, if the internet connection is moderate, analysis can be performed at an appropriate timing. Thus, the analysis unit can adjust the timing of analysis according to the user's internet connection status. Specifically, the analysis unit acquires internet connection status (e.g., communication speed, packet loss rate, connection stability score, etc.) from the user terminal or network monitor in real time and inputs it as a feature vector to the AI model. Examples of input include network status data such as “Communication speed: 0.5 Mbps, packet loss rate: 10%”, “Communication speed: 20 Mbps, packet loss rate: 0%”, “Communication speed: 5 Mbps, packet loss rate: 2%”. The analysis unit applies control algorithms (e.g., threshold determination, rule-based control, reinforcement learning, etc.) that automatically switch the timing of analysis processing (e.g., immediate analysis, batch analysis, temporary suspension of analysis, etc.) and the granularity of analysis content (e.g., detailed analysis, summary analysis, important events only, etc.) according to connection status. Examples of AI model output include control signals such as “Analysis timing: temporary suspension (communication speed 0.5 Mbps, packet loss rate 10%)”, “Analysis timing: real-time (communication speed 20 Mbps, packet loss rate 0%)”, “Analysis timing: 10-minute intervals (communication speed 5 Mbps, packet loss rate 2%)”. The analysis unit automatically adjusts the analysis pipeline and database access scheduler based on these control signals. In subsequent processing, optimization of network load and balance control of analysis quality are realized, contributing to improved user experience and enhanced system stability. As a technical effect, the analysis unit achieves efficient use of network resources, reduction of analysis delay, and improved system flexibility by realizing real-time network information analysis and automatic analysis timing optimization by AI, which differs from conventional fixed-timing analysis and manual connection status monitoring. Specific application fields include network-adaptive analysis for messenger applications, load balancing for cloud services, low-communication analysis for IoT devices, and improved user experience for mobile applications.

The generation unit can customize the display content of rankings by considering the user's past ranking viewing history when generating rankings. For example, ranking content that the user has frequently viewed in the past can be preferentially displayed. New rankings can also be generated based on ranking content that the user has shown interest in previously. Furthermore, rankings with high relevance can be displayed by referring to the user's past ranking viewing history. Thus, the generation unit can customize the display content of rankings based on the user's past ranking viewing history. Specifically, the generation unit stores each user's past ranking viewing history data (e.g., list of viewed ranking IDs, number of views, viewing time, feedback scores, etc.) in a time series database and extracts these as feature vectors (e.g., ranking category usage frequency vector, viewing tendency by time zone, past feedback scores, etc.). The generation unit applies recommendation algorithms (e.g., collaborative filtering, content-based recommendation, clustering) and ranking generation optimization algorithms (e.g., decision trees, neural networks, etc.) using these features as input, and performs priority display of ranking content that best matches the user's past interest tendencies, generation of new rankings, and automatic extraction of highly relevant rankings. Examples of AI model input include “User A's ranking viewing history for the past 30 days (ranking ID array, view count distribution)”, “User B's ranking viewing history with feedback”, and so on. Examples of AI model output include control signals such as “Recommended display ranking: music topic, reason for recommendation: high past viewing frequency”, “Recommended display ranking: gourmet-related, reason for recommendation: high feedback score”. The generation unit automatically customizes the order and content of ranking data based on these outputs to optimize the user experience. In subsequent processing, the customized rankings are passed to the visualization unit and presented in an interface optimized for the user's interests and behavior history. As a technical effect, the generation unit achieves improved personalization for each user, increased efficiency of information acquisition, and improved system flexibility by realizing analysis of past history and automatic optimization by AI, which differs from conventional static ranking display and manual customization. Specific application fields include personalized ranking for messenger applications, trend visualization for SNS, progress feedback for online learning, and user-adaptive display for marketing dashboards.

The visualization unit can adjust the display format of rankings according to the screen size of the user's device. For example, on a small smartphone screen, the ranking can be displayed in a vertical scroll format. On a large tablet screen, the ranking can be displayed in a horizontal scroll format. Furthermore, on a wide desktop screen, the ranking can be displayed in a grid format. Thus, the visualization unit can adjust the display format of rankings according to the screen size of the user's device. Specifically, the visualization unit acquires device information (e.g., screen resolution, screen size, device type, etc.) from the user terminal in real time and inputs these as feature vectors (e.g., numerical screen size, one-hot vector for device type, etc.) to the AI model. Based on device information, the visualization unit applies display layout optimization algorithms (e.g., decision trees, rule-based classifiers, neural networks, etc.) to automatically select the optimal display method. Examples of AI model input include “Device type: smartphone, screen size: 5.5 inches”, “Device type: tablet, screen size: 10 inches”, “Device type: desktop, screen size: 24 inches”, and so on. Examples of AI model output include control signals such as “Recommended display method: vertical scroll list”, “Recommended display method: horizontal scroll list”, “Recommended display method: grid format”. The visualization unit automatically adjusts the display layout, font size, button placement, interaction method, etc., for rankings and trend information based on these control signals. In subsequent processing, the optimized display method is reflected in the user interface, contributing to improved user experience and information acquisition efficiency. As a technical effect, the visualization unit achieves improved flexibility for multi-device support, increased user satisfaction, and improved system maintainability by realizing real-time device information analysis and automatic layout optimization by AI, which differs from conventional fixed screen design and manual device adaptation. Specific application fields include multi-device compatible UI for messenger applications, responsive design for SNS, device-optimized display for online learning platforms, and information presentation for wearable devices.

The collection unit can estimate a user's emotion and adjust the content of data collection based on the estimated emotion of the user. For example, if the user is feeling stressed, the collection unit can preferentially collect data on topics that help the user relax. If the user is relaxed, it can collect data on interesting topics. Furthermore, if the user is excited, it can collect data on topics that require immediate response. Thus, the collection unit can adjust the content of data collection based on the user's emotion. Specifically, the collection unit is equipped with a multimodal AI model that combines a facial expression recognition module (e.g., extraction of facial feature points from images), an audio analysis module (e.g., extraction of MFCC and pitch features from audio waveforms), and a speech text analysis module (e.g., emotional vocabulary scoring) for user emotion estimation. The collection unit inputs these features (e.g., facial landmark coordinate arrays, audio spectrum vectors, emotional vocabulary frequency vectors, etc.) as input tensors to the AI model, which outputs emotion classification (e.g., stress, relaxation, excitement, etc.). Examples of input include “User A's facial image+audio data+utterance text”, “User B's audio only”, and so on. Examples of AI model output include structured data such as “Estimated emotion: stress, confidence 0.88”, “Estimated emotion: relaxation, confidence 0.93”, “Estimated emotion: excitement, confidence 0.81”. The collection unit generates a priority list of data to be collected according to the estimated emotion (e.g., relaxing topics when relaxed, highly immediate topics when excited, etc.), and automatically switches the collection order and targets of the data collection module. In subsequent processing, high-priority data is quickly passed to the analysis unit and ranking generation unit, contributing to optimization of user experience and system efficiency. As a technical effect, the collection unit achieves data collection tailored to the user's psychological state, rapid acquisition of important data, and overall system efficiency by realizing automatic priority control linked to real-time emotion estimation by AI, which differs from conventional uniform collection and manual priority setting. Specific application fields include emotion-adaptive data collection for messenger applications, stress monitoring for wearable devices, concentration-adaptive material presentation for online learning, and emotion response optimization for customer support.

The analysis unit can estimate a user's emotion and adjust the display method of analysis results based on the estimated emotion of the user. For example, if the user is nervous, a simple and highly visible display method can be provided. If the user is relaxed, a display method including detailed information can be provided. Furthermore, if the user is excited, a visually attractive display method can be provided. Thus, the analysis unit can adjust the display method of analysis results based on the user's emotion. Specifically, the analysis unit is equipped with a multimodal AI model that combines a facial expression recognition module (e.g., extraction of feature points from facial images), an audio analysis module (e.g., extraction of emotional features from audio waveforms), and a text analysis module (e.g., extraction of emotional vocabulary from utterance content) for user emotion estimation. The analysis unit inputs these features (e.g., facial landmark coordinates, MFCC vectors, emotional vocabulary scores) as input tensors to the AI model, which outputs emotion classification (e.g., nervousness, relaxation, excitement, etc.). Examples of input include “User A's facial image+audio data+utterance text”, “User B's audio only”, and so on. Examples of AI model output include structured data such as “Estimated emotion: nervousness, confidence 0.90”, “Estimated emotion: relaxation, confidence 0.88”. The analysis unit automatically switches the display method of analysis results according to the estimated emotion (e.g., simple text display, detailed report with graphs, visual display with animation and enhanced colors, etc.). For example, in a nervous state, only the main points are displayed in large text as bullet points; in a relaxed state, detailed statistical graphs and topic distribution diagrams are displayed; and in an excited state, interactive visuals and animations are used. In subsequent processing, the analysis results are passed to the visualization unit and presented in an interface optimized for the user's emotional state. As a technical effect, the analysis unit achieves improved user experience, enhanced information comprehension, and increased system flexibility by realizing automatic display optimization linked to real-time emotion estimation by AI, which differs from conventional uniform display and manual screen design. Specific application fields include display of analysis results for messenger applications, trend analysis reports for SNS, progress feedback for online learning, and stress-adaptive response for customer support.

The generation unit can estimate a user's emotion and adjust the display order of rankings based on the estimated emotion of the user. For example, if the user is relaxed, detailed rankings can be displayed. If the user is in a hurry, concise rankings can be displayed. Furthermore, if the user is excited, visually attractive rankings can be displayed. Thus, the generation unit can adjust the display order of rankings based on the user's emotion. Specifically, the generation unit receives the user's emotion label (e.g., relaxation, in a hurry, excitement, etc.) and confidence score from the emotion estimation module as input and executes a ranking display order control algorithm. The generation unit automatically switches the order of ranking items (e.g., order by topic importance, trendiness, user interest, visual impact, etc.) and display format (e.g., detailed list, summary list, display with animation, etc.) according to the emotional state. Examples of AI model input include “User A: emotion label ‘relaxation’, confidence 0.91”, “User B: emotion label ‘in a hurry’, confidence 0.87”, and so on. Examples of AI model output include control signals such as “Display order: by importance, detailed display”, “Display order: by summary, concise display”. The generation unit rearranges ranking data and extracts display content based on these control signals to optimize the user experience. In subsequent processing, the generated rankings are passed to the visualization unit and presented in an interface optimized for the user's emotional state. As a technical effect, the generation unit achieves improved user experience, enhanced information comprehension, and increased system flexibility by realizing automatic display order optimization linked to real-time emotion estimation by AI, which differs from conventional fixed display order and manual sorting. Specific application fields include emotion-adaptive ranking display for messenger applications, user state-linked trend presentation for SNS, concentration-adaptive material display for online learning, and stress-adaptive FAQ presentation for customer support.

The visualization unit can estimate a user's emotion and adjust the operation procedure of visualization based on the estimated emotion of the user. For example, if the user is nervous, a simple and intuitive operation procedure can be provided. If the user is relaxed, a detailed operation procedure can be provided. Furthermore, if the user is excited, a visually attractive operation procedure can be provided. Thus, the visualization unit can adjust the operation procedure of visualization based on the user's emotion. Specifically, the visualization unit is equipped with a multimodal AI model that combines a facial expression recognition module (e.g., extraction of feature points from facial images), an audio analysis module (e.g., extraction of emotional features from audio waveforms), and a text analysis module (e.g., extraction of emotional vocabulary from utterance content) for user emotion estimation. The visualization unit inputs these features (e.g., facial landmark coordinates, MFCC vectors, emotional vocabulary scores) as input tensors to the AI model, which outputs emotion classification (e.g., nervousness, relaxation, excitement, etc.). Examples of input include “User A's facial image+audio data+utterance text”, “User B's audio only”, and so on. Examples of AI model output include structured data such as “Estimated emotion: nervousness, confidence 0.90”, “Estimated emotion: relaxation, confidence 0.88”. The visualization unit automatically switches the operation procedure of visualization according to the estimated emotion (e.g., simple one-tap operation, detailed guided operation, interaction with animation and enhanced colors, etc.). For example, in a nervous state, only the main functions are presented with large buttons; in a relaxed state, detailed help and tutorials are displayed; and in an excited state, interactive animations and gamification elements are added. In subsequent processing, the operation procedure is reflected in the user interface, realizing an operation experience optimized for the user's emotional state. As a technical effect, the visualization unit achieves improved user experience, reduced operation errors, and increased system flexibility by realizing automatic operation procedure optimization linked to real-time emotion estimation by AI, which differs from conventional uniform operation design and manual procedure adjustment. Specific application fields include emotion-adaptive UI for messenger applications, interaction optimization for SNS, operation guide presentation for online learning, and stress-adaptive navigation for customer support.

The estimation unit can estimate a user's emotion and improve the accuracy of age group estimation based on the estimated emotion of the user. For example, if the user is relaxed, age group can be estimated based on detailed information. If the user is in a hurry, age group can be estimated based on concise information. Furthermore, if the user is excited, age group can be estimated based on visually attractive information. Thus, the estimation unit can improve the accuracy of age group estimation based on the user's emotion. Specifically, the estimation unit is equipped with a multimodal AI model that combines a facial expression recognition module (e.g., extraction of facial feature points from images), an audio analysis module (e.g., extraction of MFCC and pitch features from audio waveforms), and a speech text analysis module (e.g., emotional vocabulary scoring) for user emotion estimation. The estimation unit inputs these features (e.g., facial landmark coordinate arrays, audio spectrum vectors, emotional vocabulary frequency vectors, etc.) as input tensors to the AI model, which outputs emotion classification (e.g., relaxation, in a hurry, excitement, etc.). Examples of input include “User A's facial image+audio data+utterance text”, “User B's audio only”, and so on. Examples of AI model output include structured data such as “Estimated emotion: relaxation, confidence 0.91”, “Estimated emotion: in a hurry, confidence 0.88”. The estimation unit automatically switches the amount of input information and analysis detail level for the age group estimation algorithm (e.g., use of detailed features, use of summary features, emphasis on visual features, etc.) according to the estimated emotion. For example, in a relaxed state, detailed behavioral history and utterance content are used as multidimensional feature vectors; in a hurried state, only key features are extracted for rapid estimation; and in an excited state, visually emphasized information (e.g., input data with colors or animation) is utilized. In subsequent processing, the age group estimation results are passed to the visualization unit and analysis unit, contributing to optimization of user experience and system efficiency. As a technical effect, the estimation unit achieves improved estimation accuracy, optimized computational resources, and enhanced user experience by realizing automatic estimation accuracy optimization linked to real-time emotion estimation by AI, which differs from conventional uniform age group estimation and manual adjustment of detail level. Specific application fields include age group estimation for messenger applications, user attribute estimation for SNS, individual optimization for online learning, and target group estimation for marketing.

The analysis unit can estimate a user's emotion and adjust the analysis method of natural language processing based on the estimated emotion of the user. For example, if the user is relaxed, detailed analysis can be performed. If the user is in a hurry, concise analysis can be performed. Furthermore, if the user is excited, visually attractive analysis can be performed. Thus, the analysis unit can adjust the analysis method of natural language processing based on the user's emotion. Specifically, the analysis unit is equipped with a multimodal AI model that combines a facial expression recognition module (e.g., extraction of feature points from facial images), an audio analysis module (e.g., extraction of emotional features from audio waveforms), and a text analysis module (e.g., extraction of emotional vocabulary from utterance content) for user emotion estimation. The analysis unit inputs these features (e.g., facial landmark coordinates, MFCC vectors, emotional vocabulary scores) as input tensors to the AI model, which outputs emotion classification (e.g., relaxation, in a hurry, excitement, etc.). Examples of input include “User A's facial image+audio data+utterance text”, “User B's audio only”, and so on. Examples of AI model output include structured data such as “Estimated emotion: relaxation, confidence 0.91”, “Estimated emotion: in a hurry, confidence 0.88”. The analysis unit automatically switches the analysis method of natural language processing according to the estimated emotion (e.g., detailed contextual analysis, summary analysis, analysis with visual emphasis, etc.). For example, in a relaxed state, detailed topic distribution and relationship analysis are performed; in a hurried state, only key word extraction and summarization are performed; and in an excited state, analysis results with animation and enhanced colors are generated. In subsequent processing, the analysis results are passed to the visualization unit and presented in an interface optimized for the user's emotional state. As a technical effect, the analysis unit achieves improved user experience, enhanced information comprehension, and increased system flexibility by realizing automatic optimization of analysis methods linked to real-time emotion estimation by AI, which differs from conventional uniform analysis processing and manual adjustment of detail level. Specific application fields include talk content analysis for messenger applications, trend analysis for SNS, progress analysis for online learning, and stress-adaptive response for customer support.

The following is a brief description of the processing flow of Example of the Embodiment. Specifically, the system operates in cooperation among the collection unit, analysis unit, generation unit, and visualization unit modules, automating and optimizing the entire process from collection of user behavior data to generation and display of rankings. The collection unit collects multidimensional tensor data from user terminals, such as click data, browsing history, message content, device information, and sensor data for emotion estimation, and stores it in a database. The analysis unit applies natural language processing algorithms (e.g., BERT-based contextual embedding, topic extraction by LDA), image and audio analysis algorithms, and emotion estimation AI models to the collected data as input, extracting and classifying feature vectors of user attributes, emotional states, and talk content. The generation unit generates topic rankings by age group, attribute, region, and interest based on the feature vectors and talk content received from the analysis unit, and applies ranking generation algorithms (e.g., TF-IDF score aggregation, co-occurrence network analysis, clustering, etc.) and personalization control. The visualization unit automatically converts the ranking data received from the generation unit into the optimal display layout and interaction method according to the user's device information, interests, emotional state, and operation history, and presents it on the user interface. Each module cooperates through AI model input/output examples (e.g., input=User A's facial image+audio data+utterance text, output=estimated emotion: relaxation, confidence 0.91, etc.) and subsequent processing (e.g., automatic adjustment of ranking generation parameters, optimization of display layout, etc.), realizing automation, efficiency, and improved personalization of the entire system. As a technical effect, the system achieves improved user experience, increased efficiency of information acquisition, and enhanced system flexibility and scalability by combining multidimensional feature analysis and automatic optimization by AI, which differs from conventional manual data collection, analysis, display, and static ranking generation. Specific application fields include topic ranking generation for messenger applications, trend analysis for SNS, individual optimization for online learning, and user-adaptive display for marketing dashboards.

Step 1: The collection unit collects user behavior data. User behavior data includes click data, browsing history, message content, and the like. The collection unit collects user behavior data from messenger applications, including detailed data such as content of conversations with friends, topics in group chats, and frequently used words. Step 2: The analysis unit analyzes the data collected by the collection unit and extracts talk content of users in each age group. The analysis unit utilizes the age group estimation function of the messenger application to estimate age group from user profile information or talk content, and classifies talk content of users in each age group. Step 3: The generation unit generates topic rankings by age group based on the talk content extracted by the analysis unit. The generation unit displays, in a ranking format, words that users in each age group are discussing, such as words frequently used by users in their teens or twenties. Step 4: The visualization unit visualizes the rankings generated by the generation unit to users. The visualization unit displays the ranking on a home screen of a messenger application or on a dedicated ranking page, visualizing the ranking to users. Specifically, in Step 1, the system collects multidimensional tensor data from user terminals, such as click event logs, browsing page URL lists, message text, device information, and sensor data for emotion estimation, and stores it in a database. In Step 2, the analysis unit applies natural language processing algorithms (e.g., BERT-based contextual embedding, topic extraction by LDA), image and audio analysis algorithms, and emotion estimation AI models to the collected data as input, extracting and classifying feature vectors of user attributes, emotional states, and talk content. Examples of AI model input include “User A's message text+profile information”, “User B's group chat content+emotion estimation features”, and so on. Examples of AI model output include structured data such as “Estimated age group: teens, main topics: games, music”, “Estimated age group: twenties, main topics: work, travel”. In Step 3, the generation unit generates topic rankings by age group based on the feature vectors and talk content received from the analysis unit, and applies ranking generation algorithms (e.g., TF-IDF score aggregation, co-occurrence network analysis, clustering, etc.) and personalization control. Examples of output include structured data such as “Teens ranking: 1st ‘games’, 2nd ‘music’, 3rd ‘friends’”, “Twenties ranking: 1st ‘work’, 2nd ‘travel’, 3rd ‘gourmet’”. In Step 4, the visualization unit automatically converts the ranking data received from the generation unit into the optimal display layout and interaction method according to the user's device information, interests, emotional state, and operation history, and presents it on the user interface. Examples of AI model input include “Device type: smartphone, emotional state: relaxation, interest tags: music, movies”, and so on. Examples of AI model output include control signals such as “Recommended display method: graph format, reason for recommendation: high past usage frequency”. In subsequent processing, the system collects user operation history and feedback and utilizes them for continuous optimization of ranking generation and display logic. As a technical effect, the system achieves improved user experience, increased efficiency of information acquisition, and enhanced system flexibility and scalability by combining multidimensional feature analysis and automatic optimization by AI, which differs from conventional manual data collection, analysis, display, and static ranking generation. Specific application fields include topic ranking generation for messenger applications, trend analysis for SNS, individual optimization for online learning, and user-adaptive display for marketing dashboards.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, generation unit, and visualization unit is implemented by at least one of, for example, a smart device 14 and a data processing apparatus 12. For example, the collection unit is implemented by a control unit 46A of the smart device 14 and collects user behavior data of a messenger application. The analysis unit is implemented, for example, by a specific processing unit 290 of the data processing apparatus 12 and analyzes the collected data to extract talk content of users in each age group. The generation unit is implemented, for example, by the specific processing unit 290 of the data processing apparatus 12 and generates topic rankings by age group based on the extracted talk content. The visualization unit is implemented, for example, by the control unit 46A of the smart device 14 and visualizes the generated rankings to users. The correspondence between each unit and the apparatus or control unit is not limited to the examples described above and various modifications are possible.

### Second Embodiment

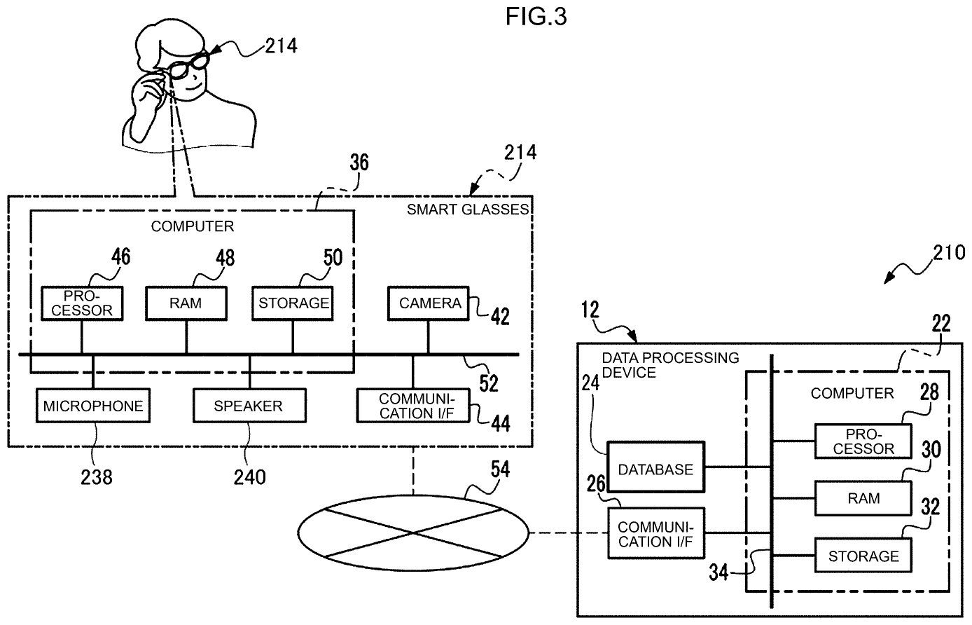

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

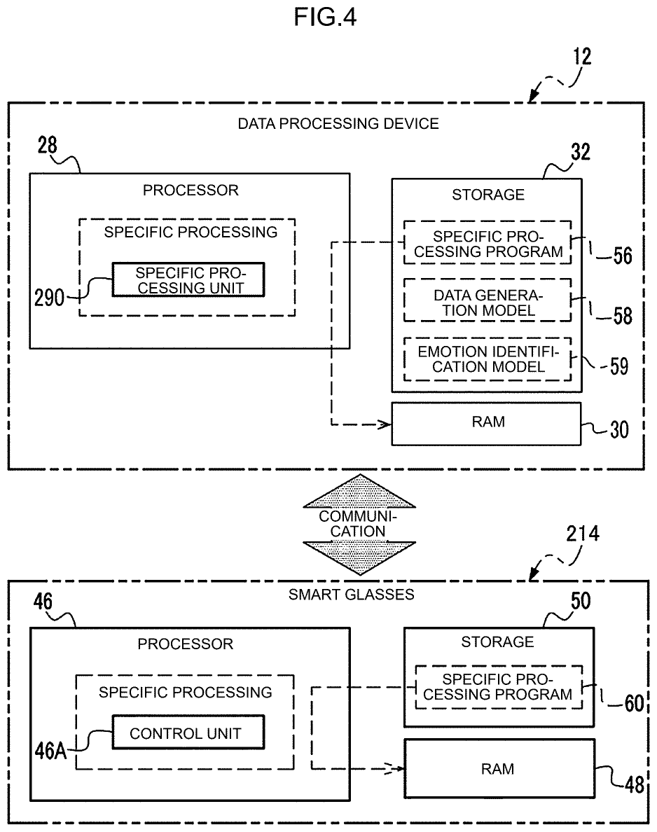

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, generation unit, and visualization unit is implemented by at least one of, for example, smart glasses 214 and a data processing apparatus 12. For example, the collection unit is implemented by a control unit 46A of the smart glasses 214 and collects user behavior data of a messenger application. The analysis unit is implemented, for example, by a specific processing unit 290 of the data processing apparatus 12 and analyzes the collected data to extract talk content of users in each age group. The generation unit is implemented, for example, by the specific processing unit 290 of the data processing apparatus 12 and generates topic rankings by age group based on the extracted talk content. The visualization unit is implemented, for example, by the control unit 46A of the smart glasses 214 and visualizes the generated rankings to users. The correspondence between each unit and the apparatus or control unit is not limited to the examples described above and various modifications are possible.

### Third Embodiment

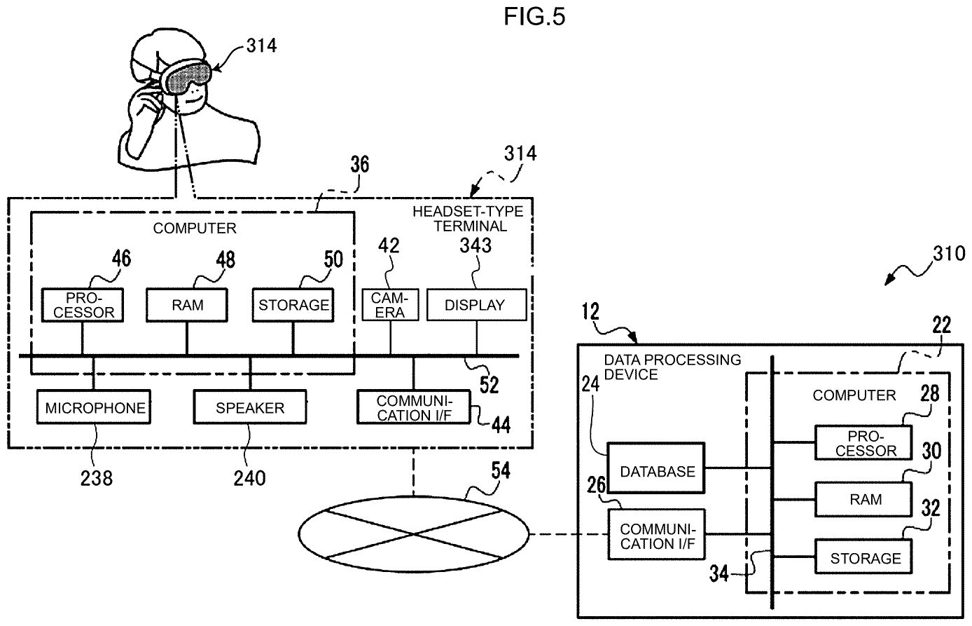

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

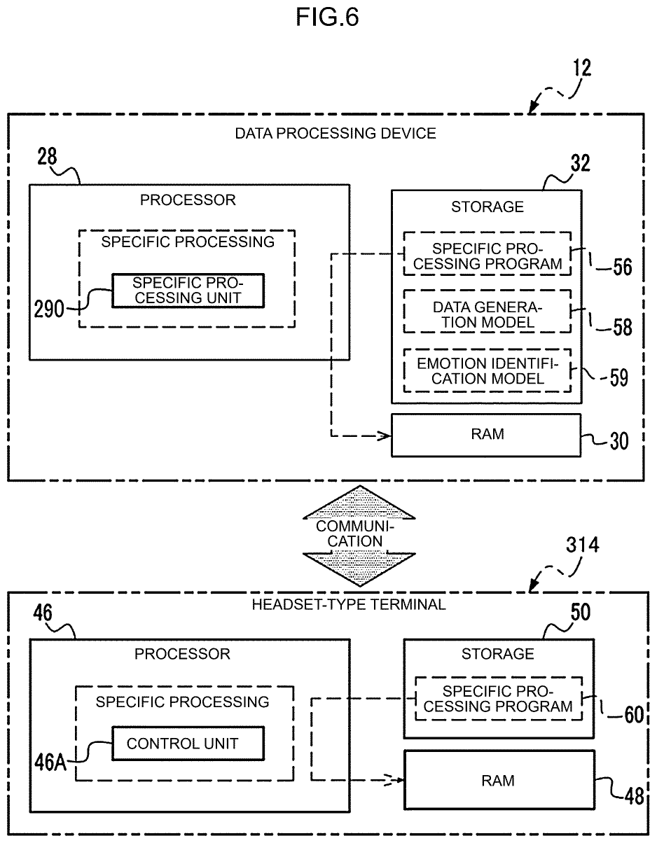

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, generation unit, and visualization unit is implemented by at least one of, for example, a headset-type terminal 314 and a data processing apparatus 12. For example, the collection unit is implemented by a control unit 46A of the headset-type terminal 314 and collects user behavior data of a messenger application. The analysis unit is implemented, for example, by a specific processing unit 290 of the data processing apparatus 12 and analyzes the collected data to extract talk content of users in each age group. The generation unit is implemented, for example, by the specific processing unit 290 of the data processing apparatus 12 and generates topic rankings by age group based on the extracted talk content. The visualization unit is implemented, for example, by the control unit 46A of the headset-type terminal 314 and visualizes the generated rankings to users. The correspondence between each unit and the apparatus or control unit is not limited to the examples described above and various modifications are possible.

### Fourth Embodiment

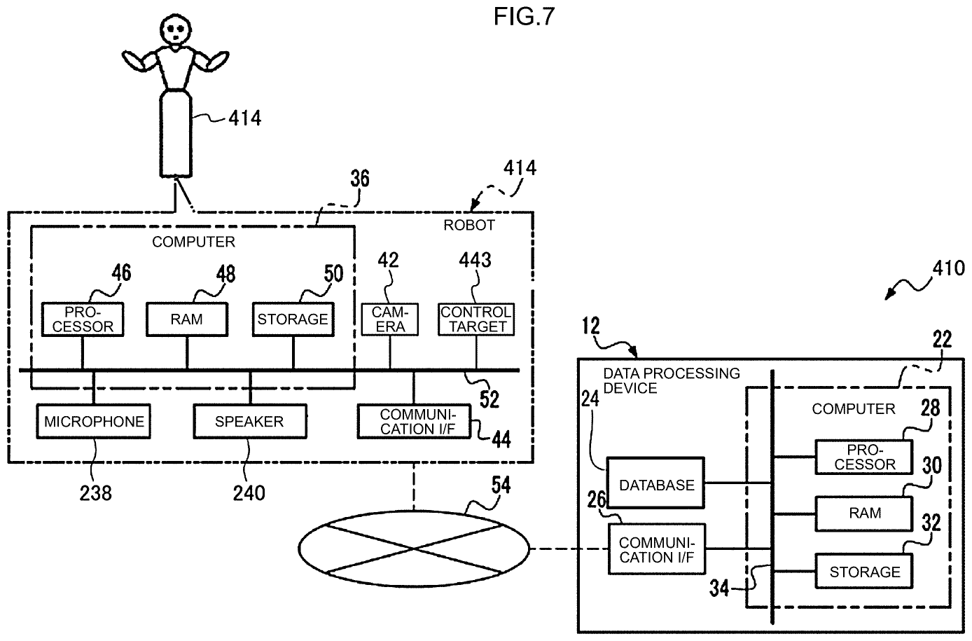

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

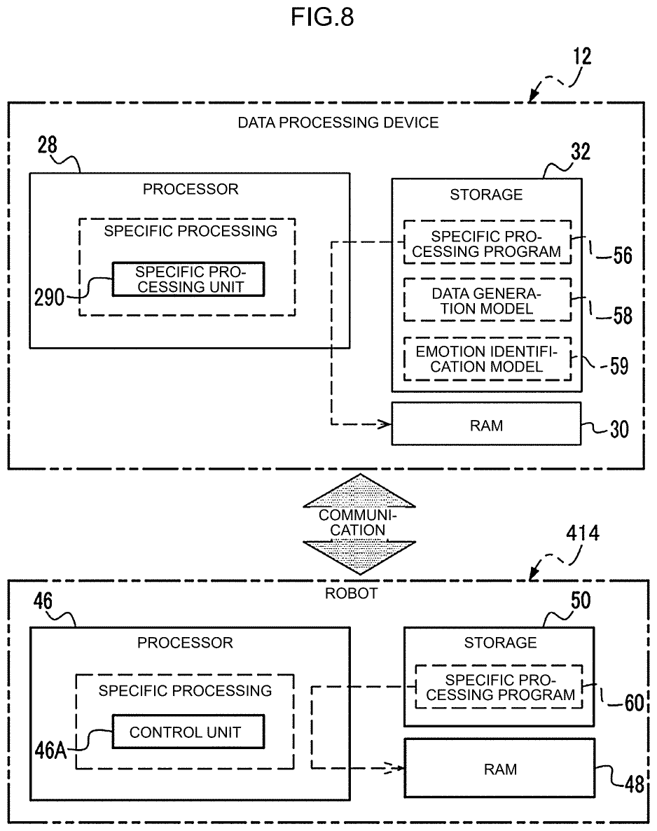

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, generation unit, and visualization unit is implemented by at least one of, for example, a robot 414 and a data processing apparatus 12. For example, the collection unit is implemented by a control unit 46A of the robot 414 and collects user behavior data of a messenger application. The analysis unit is implemented, for example, by a specific processing unit 290 of the data processing apparatus 12 and analyzes the collected data to extract talk content of users in each age group. The generation unit is implemented, for example, by the specific processing unit 290 of the data processing apparatus 12 and generates topic rankings by age group based on the extracted talk content. The visualization unit is implemented, for example, by the control unit 46A of the robot 414 and visualizes the generated rankings to users. The correspondence between each unit and the apparatus or control unit is not limited to the examples described above and various modifications are possible.

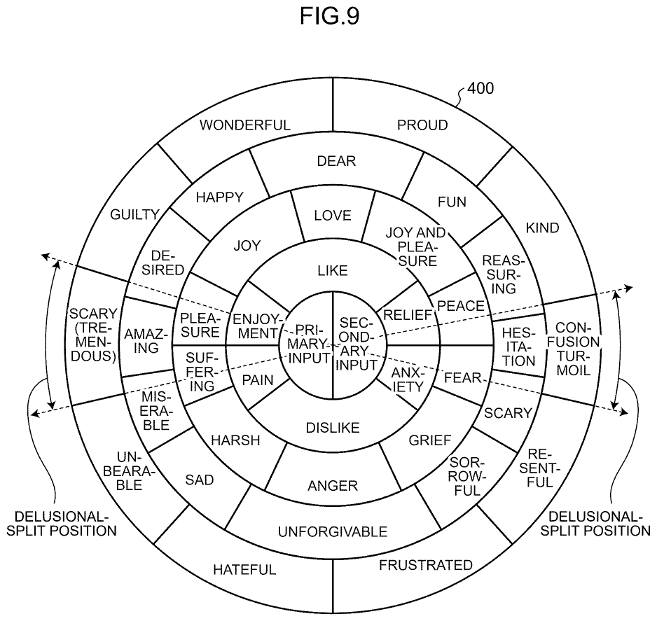

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

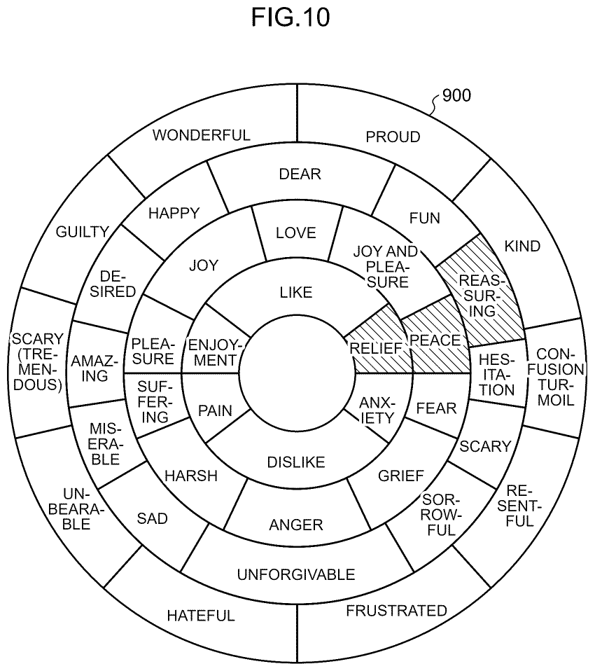

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### (Supplementary Note 1)

A system comprising: a collection unit configured to collect user behavior data; an analysis unit configured to analyze the data collected by the collection unit and extract talk content of users in each age group; a generation unit configured to generate topic rankings by age group based on the talk content extracted by the analysis unit; and a visualization unit configured to visualize the rankings generated by the generation unit to users.

### (Supplementary Note 2)

The system according to Supplementary Note 1, wherein the analysis unit comprises an estimation unit configured to estimate the age group from user profile information or talk content.

### (Supplementary Note 3)

The system according to Supplementary Note 1, wherein the analysis unit is configured to analyze talk content using natural language processing technology.

### (Supplementary Note 4)

The system according to Supplementary Note 1, wherein the generation unit is configured to display, in a ranking format, words that users in each age group are discussing.

### (Supplementary Note 5)

The system according to Supplementary Note 1, wherein the visualization unit is configured to display the ranking on a home screen of a messenger application or on a dedicated ranking page.

### (Supplementary Note 6)

The system according to Supplementary Note 1, wherein the visualization unit is configured to provide a more accurate ranking by allowing users to register their own age group or interests.

### (Supplementary Note 7)

The system according to Supplementary Note 1, wherein the collection unit is configured to estimate a user's emotion and adjust the timing of data collection based on the estimated emotion of the user.

### (Supplementary Note 8)

The system according to Supplementary Note 1, wherein the collection unit is configured to analyze a user's past behavior data and select a data collection method.

### (Supplementary Note 9)

The system according to Supplementary Note 1, wherein the collection unit is configured to perform filtering during data collection based on the user's current activity status or field of interest.

### (Supplementary Note 10)

The system according to Supplementary Note 1, wherein the collection unit is configured to estimate a user's emotion and determine the priority of data to be collected based on the estimated emotion of the user.

### (Supplementary Note 11)

The system according to Supplementary Note 1, wherein the collection unit is configured to preferentially collect highly relevant data by considering the user's geographic location information during data collection.

### (Supplementary Note 12)

The system according to Supplementary Note 1, wherein the collection unit is configured to analyze the user's social media activity and collect relevant data during data collection.

### (Supplementary Note 13)

The system according to Supplementary Note 1, wherein the analysis unit is configured to estimate a user's emotion and adjust the expression method of analysis based on the estimated emotion of the user.

### (Supplementary Note 14)

The system according to Supplementary Note 1, wherein the analysis unit is configured to adjust the level of detail of analysis based on the importance of the data during analysis.

### (Supplementary Note 15)

The system according to Supplementary Note 1, wherein the analysis unit is configured to apply different analysis algorithms according to the category of data during analysis.

### (Supplementary Note 16)

The system according to Supplementary Note 1, wherein the analysis unit is configured to estimate a user's emotion and adjust the length of analysis based on the estimated emotion of the user.

### (Supplementary Note 17)

The system according to Supplementary Note 1, wherein the analysis unit is configured to determine the priority of analysis based on the timing of data collection during analysis.

### (Supplementary Note 18)

The system according to Supplementary Note 1, wherein the analysis unit is configured to adjust the order of analysis based on the relevance of the data during analysis.

### (Supplementary Note 19)

The system according to Supplementary Note 1, wherein the generation unit is configured to estimate a user's emotion and adjust the criteria for generating rankings based on the estimated emotion of the user.

### (Supplementary Note 20)

The system according to Supplementary Note 1, wherein the generation unit is configured to improve the accuracy of generation by considering the interrelationships of data during ranking generation.

### (Supplementary Note 21)

The system according to Supplementary Note 1, wherein the generation unit is configured to perform generation by considering attribute information of data submitters during ranking generation.

### (Supplementary Note 22)

The system according to Supplementary Note 1, wherein the generation unit is configured to estimate a user's emotion and adjust the display order of rankings based on the estimated emotion of the user.

### (Supplementary Note 23)

The system according to Supplementary Note 1, wherein the generation unit is configured to perform generation by considering the geographic distribution of data during ranking generation.

### (Supplementary Note 24)

The system according to Supplementary Note 1, wherein the generation unit is configured to improve the accuracy of generation by referring to related literature of the data during ranking generation.

### (Supplementary Note 25)

The system according to Supplementary Note 1, wherein the visualization unit is configured to estimate a user's emotion and adjust the display method of visualization based on the estimated emotion of the user.

### (Supplementary Note 26)

The system according to Supplementary Note 1, wherein the visualization unit is configured to select an optimal display method by referring to the user's past operation history during visualization display.

### (Supplementary Note 27)

The system according to Supplementary Note 1, wherein the visualization unit is configured to select an optimal display method by considering the user's device information during visualization display.

### (Supplementary Note 28)

The system according to Supplementary Note 1, wherein the visualization unit is configured to estimate a user's emotion and adjust the operation procedure of visualization based on the estimated emotion of the user.

### (Supplementary Note 29)

The system according to Supplementary Note 1, wherein the visualization unit is configured to select an optimal display method by considering the user's interests during visualization display.

### (Supplementary Note 30)

The system according to Supplementary Note 1, wherein the visualization unit is configured to improve the display method by reflecting user feedback during visualization display.

### (Supplementary Note 31)

The system according to Supplementary Note 2, wherein the estimation unit is configured to estimate a user's emotion and improve the accuracy of age group estimation based on the estimated emotion of the user.

### (Supplementary Note 32)

The system according to Supplementary Note 2, wherein the estimation unit is configured to optimize the estimation algorithm by referring to the user's past behavior data during age group estimation.

### (Supplementary Note 33)

The system according to Supplementary Note 2, wherein the estimation unit is configured to perform estimation by considering user profile information during age group estimation.

### (Supplementary Note 34)

The system according to Supplementary Note 2, wherein the estimation unit is configured to estimate a user's emotion and adjust the display method of estimation results based on the estimated emotion of the user.

### (Supplementary Note 35)

The system according to Supplementary Note 2, wherein the estimation unit is configured to perform estimation by considering the user's geographic location information during age group estimation.

### (Supplementary Note 36)

The system according to Supplementary Note 2, wherein the estimation unit is configured to analyze the user's social media activity and improve the accuracy of estimation during age group estimation.

### (Supplementary Note 37)

The system according to Supplementary Note 3, wherein the analysis unit is configured to estimate a user's emotion and adjust the analysis method of natural language processing based on the estimated emotion of the user.

### (Supplementary Note 38)

The system according to Supplementary Note 3, wherein the analysis unit is configured to adjust the level of detail of analysis based on the importance of the data during natural language processing.

### (Supplementary Note 39)

The system according to Supplementary Note 3, wherein the analysis unit is configured to apply different analysis algorithms according to the category of data during natural language processing.

### (Supplementary Note 40)

The system according to Supplementary Note 3, wherein the analysis unit is configured to estimate a user's emotion and adjust the order of displaying analysis results of natural language processing based on the estimated emotion of the user.

### (Supplementary Note 41)

The system according to Supplementary Note 3, wherein the analysis unit is configured to determine the priority of analysis based on the timing of data collection during natural language processing.

### (Supplementary Note 42)

The system according to Supplementary Note 3, wherein the analysis unit is configured to improve the accuracy of analysis by referring to related literature of the data during natural language processing.

What is claimed is:

1. A system comprising:
circuitry configured to:
receive, from a client terminal via a packet-switched network, behavior data comprising at least one of text data, voice data, or image data;
analyze the behavior data using a natural language processing model based on a Transformer architecture to extract feature vectors and assign a demographic label to each user based on at least one of profile information or the behavior data;
generate ranking data by aggregating topic labels extracted from the behavior data according to the demographic label, the ranking data comprising topic identifiers and associated scores; and
transmit the ranking data to the client terminal via the packet-switched network, the ranking data causing the client terminal to render a visualization of the ranking data.

2. The system according to claim 1, wherein the circuitry is further configured to assign the demographic label by estimating an age group based on at least one of user profile information or talk content using a classification model.

3. The system according to claim 1, wherein the circuitry is further configured to analyze the behavior data using natural language processing technology comprising at least one of morphological analysis, dependency parsing, or semantic analysis using contextual embedding.

4. The system according to claim 1, wherein the circuitry is further configured to generate the ranking data by displaying, in a ranking format, words that users associated with each demographic label are discussing.

5. The system according to claim 1, wherein the circuitry is further configured to transmit the ranking data to cause the client terminal to display the ranking data on a home screen of an application or on a dedicated ranking page.

6. The system according to claim 1, wherein the circuitry is further configured to receive, from the client terminal via the packet-switched network, user registration data comprising at least one of a user-specified demographic category or interest tags, and to generate personalized ranking data based on the user registration data.

7. The system according to claim 1, wherein the circuitry is further configured to estimate an emotion of a user by applying an emotion identification model to the behavior data, and to adjust a timing of receiving the behavior data based on the estimated emotion.

8. The system according to claim 1, wherein the circuitry is further configured to analyze past behavior data associated with a user and select a data collection method based on the past behavior data using at least one of a clustering algorithm or a time-series prediction model.

9. The system according to claim 1, wherein the circuitry is further configured to perform filtering during data collection based on at least one of a current activity status or a field of interest of a user by applying a filtering rule generation algorithm.

10. The system according to claim 1, wherein the circuitry is further configured to estimate an emotion of a user by applying an emotion identification model to the behavior data, and to determine a priority of the behavior data to be received based on the estimated emotion.

11. The system according to claim 1, wherein the circuitry is further configured to receive geographic location information from the client terminal via the packet-switched network, and to preferentially collect behavior data associated with a geographic region corresponding to the geographic location information.

12. The system according to claim 1, wherein the circuitry is further configured to estimate an emotion of a user by applying an emotion identification model to the behavior data, and to adjust an expression method of analysis results based on the estimated emotion.

13. The system according to claim 1, wherein the circuitry is further configured to calculate an importance score for the behavior data, and to adjust a level of detail of analysis based on the importance score.

14. The system according to claim 1, wherein the circuitry is further configured to apply different analysis algorithms according to a category of the behavior data, such that for text data, the circuitry applies a natural language processing algorithm, for image data, the circuitry applies an image classification algorithm using a convolutional neural network, and for voice data, the circuitry applies a voice analysis algorithm.

15. The system according to claim 1, wherein the circuitry is further configured to estimate an emotion of a user by applying an emotion identification model to the behavior data, and to adjust criteria for generating the ranking data based on the estimated emotion.

16. The system according to claim 1, wherein the circuitry is further configured to improve accuracy of the ranking data by considering interrelationships of the behavior data using at least one of co-occurrence network analysis or clustering.

17. The system according to claim 1, wherein the circuitry is further configured to generate the ranking data by considering attribute information of data submitters comprising at least one of age, gender, occupation, or region.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model; and
circuitry configured to:
receive, from the client terminal via the communication interface, behavior data comprising at least one of text data input via the touch panel, voice data captured by the microphone, or image data captured by the camera;
analyze the behavior data using a natural language processing model based on a Transformer architecture to extract feature vectors comprising at least one of word embedding vectors or topic distribution vectors;
assign a demographic label to each user by inputting at least one of profile information or the behavior data into a classification model;
estimate an emotion of a user by applying the emotion identification model to the behavior data;
generate ranking data by aggregating topic labels extracted from the behavior data according to the demographic label, the ranking data comprising topic identifiers and associated scores;
adjust at least one of a display format or a display order of the ranking data based on the estimated emotion; and
transmit the ranking data to the client terminal via the communication interface, the ranking data causing the client terminal to render a visualization of the ranking data via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system, the method comprising:
receiving, from a client terminal via a packet-switched network, behavior data comprising at least one of text data, voice data, or image data;
analyzing the behavior data using a natural language processing model based on a Transformer architecture to extract feature vectors and assign a demographic label to each user based on at least one of profile information or the behavior data;
generating ranking data by aggregating topic labels extracted from the behavior data according to the demographic label, the ranking data comprising topic identifiers and associated scores; and
transmitting the ranking data to the client terminal via the packet-switched network, the ranking data causing the client terminal to render a visualization of the ranking data.
